(19) United States
(12) Patent Application Publication
(10) Pub. No.: US 2021/0387346 A1
(43) Pub. Date: Dec. 16, 2021

(54) HUMANOID ROBOT FOR PERFORMING MANEUVERS LIKE HUMANS

(71) Applicant: Carla R. Gillett, Sacramento, CA (US)

(72) Inventor: Carla R. Gillett, Sacramento, CA (US)

(73) Assignee: Carla R. Gillett, Sacramento, CA (US)

(21) Appl. No.: 16/852,470

(22) Filed: Apr. 18, 2020

Related U.S. Application Data
(63) Continuation-in-part of application No. 15/331,820, filed on Oct. 22, 2016, now Pat. No. 10,625,593.

(51) Int. Cl. B25J 9/16; B25J 9/08; B25J 13/08; B25J 13/00; B25J 19/00; B25J 5/00; B25J 9/10; B25J 11/00; B25J 15/00; B25J 17/02; B25J 9/00; B25J 15/04; B25J 9/12; B25J 15/02

(52) U.S. Cl. CPC B25J 9/1697; B25J 9/1676; B25J 13/088; B25J 9/161; B25J 13/006; B25J 19/005; B25J 19/0029; B25J 5/007; B25J 19/0004; B25J 9/104; B25J 13/086; B25J 11/0035; B25J 15/0009; B25J 19/0075; B25J 17/0258; B25J 9/1651; B25J 9/0012; B25J 13/085; B25J 15/04; B25J 9/126; B25J 11/0015; B25J 13/003; B25J 9/1633; B25J 15/02; B25J 9/1666; B25J 9/08

(57) ABSTRACT

A modular robotic vehicle (MRV) having a modular chassis configured for a vehicle utilizing two-wheel steering, four-wheel steering, six-wheel steering, eight-wheel steering controlled by a semiautonomous system or an autonomous driving system, either system is associated with operating modes which may include a two-wheel steering mode, an all-wheel steering mode, a traverse steering mode, a park mode, or an omni-directional mode utilized for steering sideways, driving diagonally or move crab like. Accordingly, during semiautonomous control a driver of the modular robotic vehicle may utilize smart I/O devices including a smartphone, tablet like devices, or a control panel to select a preferred driving mode. The driver may communicate navigation instructions via smart I/O devices to control steering, speed and placement of the MRV in respect to the operating mode. Accordingly, GPS and a wireless network provides navigation instructions during an autonomous operation involving driving, parking, docking or connecting to another MRV.

### CROSS REFERENCED TO RELATED APPLICATIONS

A notice of issuance for a continuation in part in reference to patent application Ser. No. 13/872,054, filing date: Apr. 26, 2013, title: “Robotic Omniwheel”, and also related application: 15/269,842 filing date Sep. 19, 2016, title “Yoke Module System for Powering a Motorized Wheel”, and also related application Ser. No. 12/655,569, title: “Robotic Omniwheel Vehicle” filing date: Jan. 4, 2010, and issued U.S. Pat. No. 8,430,192 B2, In Gillett.

### STATEMENT REGARDING FEDERALLY SPONSORED RESEARCH & DEVELOPMENT

Non Applicable

### THE NAMES OF PARTIES TO A JOINT RESEARCH AGREEMENT

Non Applicable

### 1. Field of the Invention

The present disclosure relates to an artificially intelligent self-balancing mobile robot system with user interaction especially capable of autonomous drive control provided by at least one traversing robotic omniwheel comprising an attitude sensoring system.

### 2. Background

Related art for compatibility the system design of the present invention provides a control platform, in addition to robotics, intelligent control also involves control of the field of occupational and meet the needs of autonomous multi-service robots for users, and for general applications. Autonomous controlled robots and robot vehicles are becoming more prevalent today and are used to perform tasks traditionally considered to work in a controlled environment indoors. As the programming technology increases, so too does the demand for robotic devices that can navigate around complex environments.

Robotic devices and associated controls, navigational systems, and other related systems are being developed for example, intelligent transportation focusing on electric driverless vehicles and hybrid forms of autonomous vehicles to transport passengers. Ideally what is essential for the advancement of robot technology is developing smart service robots and robot vehicles capable user interaction and capable of traveling on common streets and smart highway system, what's more too provide AI service robots that can verbally communicate with users providing companionship, and help out by doing domestic chores and running errands for users, and AI robot vehicles to deliver goods and cargo.

### SUMMARY

The present invention is a self-balancing robot system comprising one or more robotic omniwheels, in various aspects the self-balancing robot system offers highly intelligent robots comprising a computer operating system, a motion control system, an autonomous drive system, a wireless communication system, an electrical control system and an attitude sensing system including attitude state sensors and algorithms to achieve self-balance control of the robotic omniwheel. The self-balancing service robots comprise an articulated head system utilized for user interaction and respectively as a collective array, the robots communicate when working and when traveling in cavalcades on smart highways.

### BRIEF DESCRIPTION OF THE DRAWINGS

FIG. 1A schematically illustrates various embodiments of a first self-balancing service robot 101(A) comprising a uni-robotic omniwheel in accordance with the present disclosure.

FIG. 1B schematically illustrates various embodiments of a first self-balancing service robot 101(B) comprising at least one jointed leg coupled to uni-robotic omniwheel in accordance with the present disclosure.

FIG. 1C schematically illustrates various embodiments of a second self-balancing robot vehicle 102 comprising one or more robotic omniwheels in accordance with the present disclosure.

FIG. 2A a see though front view schematically illustrating various embodiments of the robotic omniwheel which is configured with an inflatable tire and an attitude sensing system 135 in accordance with the present disclosure.

FIG. 2B schematically illustrates various embodiments of the self-balancing robot 101(A) in accordance with the present disclosure.

FIG. 3A a see through front view of the self-balancing robot 101(A) in accordance with the present disclosure.

FIG. 3B a see through side view of the self-balancing robot 101(A) in accordance with the present disclosure.

FIG. 4A schematically illustrates various embodiments of the robotic omniwheel comprising a fender 114 and steering motor 113 in accordance with the present disclosure.

FIG. 4B schematically illustrates various embodiments of a first self-balancing service robot 101(B) comprising one jointed leg coupled to uni-robotic omniwheel in accordance with the present disclosure.

FIG. 4C schematically illustrates various embodiments of the self-balancing robot 101(B) comprising two jointed legs coupled to robotic omniwheel skates in accordance with the present disclosure.

FIG. 5A schematically illustrates various embodiments of the robotic omniwheel configured with track and belt system 107 in accordance with the present disclosure.

FIG. 5B schematically illustrates various embodiments of the self-balancing robot 101(C) comprising two robotic omniwheels configured with track and belt system in accordance with the present disclosure.

FIG. 6A schematically illustrates various embodiments of the self-balancing robot vehicle 102(A) in accordance with the present disclosure.

FIG. 6B schematically illustrates various embodiments of the self-balancing robot vehicle 102(B) in accordance with the present disclosure.

FIG. 7 schematically illustrates a block diagram of the computer operating system in accordance with the present disclosure.

FIG. 8 schematically illustrates a flowchart of the motion control system in accordance with the present disclosure.

FIG. 9 schematically illustrates a flowchart of the autonomous control system in accordance with the present disclosure.

FIG. 10 schematically illustrates a flowchart diagram of the wireless communication system in accordance with the present disclosure.

FIG. 11 schematically illustrates a block diagram of the I/O interface and network systems in accordance with the present disclosure.

FIG. 12 schematic illustrates a block diagram of the head system and LED system in accordance with the present disclosure.

FIG. 13 schematically illustrates various embodiments of a plurality of peer robots traveling in cavalcades on a smart highway, and also disclosing a third robot cargo vehicle 102(C) in accordance with the present disclosure.

### DETAILED DESCRIPTION OF THE DRAWINGS

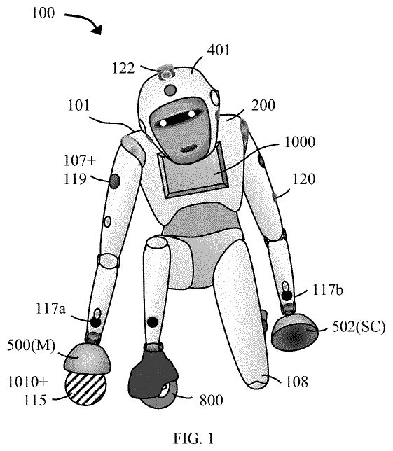

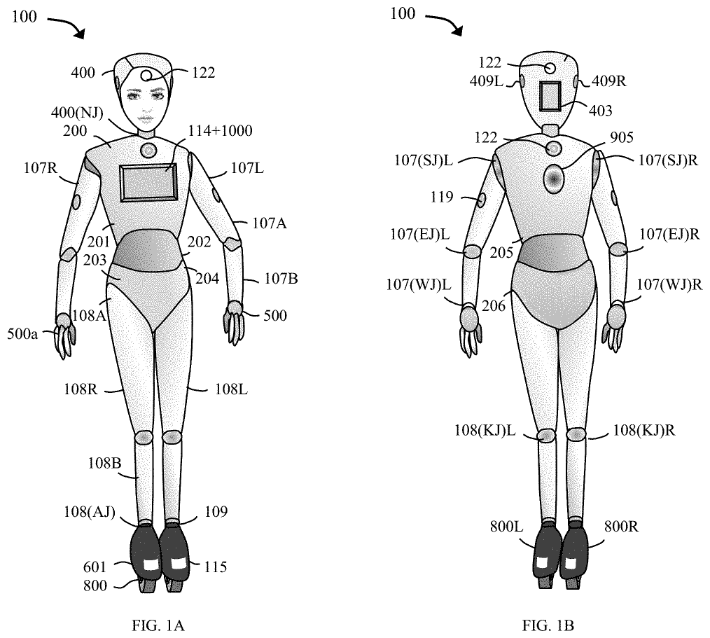

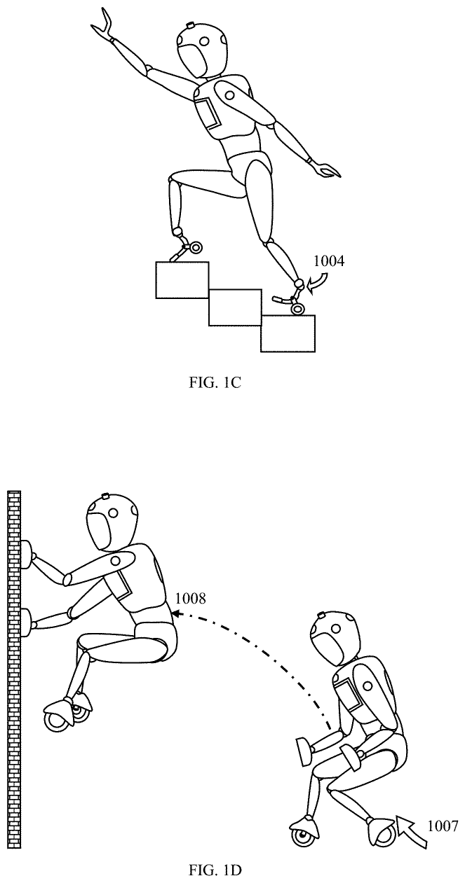

The present autonomous robot system offers an assortment of self-balancing robots that are designed with a collective set of commands configured for executable mobility and task handling in various driving environments. As FIG. 1 illustrates two robot types, the first robot is characterized in that of a humanoid service robot 101(A) and humanoid service robot 101(B), and the second robot type is characterized in that of a robot vehicle 102(A), and accordingly each robot type 101/102 can comprise an array of one or more self-balancing robotic omniwheels 103 which are configured with a tire or track to travel on common roadways and on smart highways.

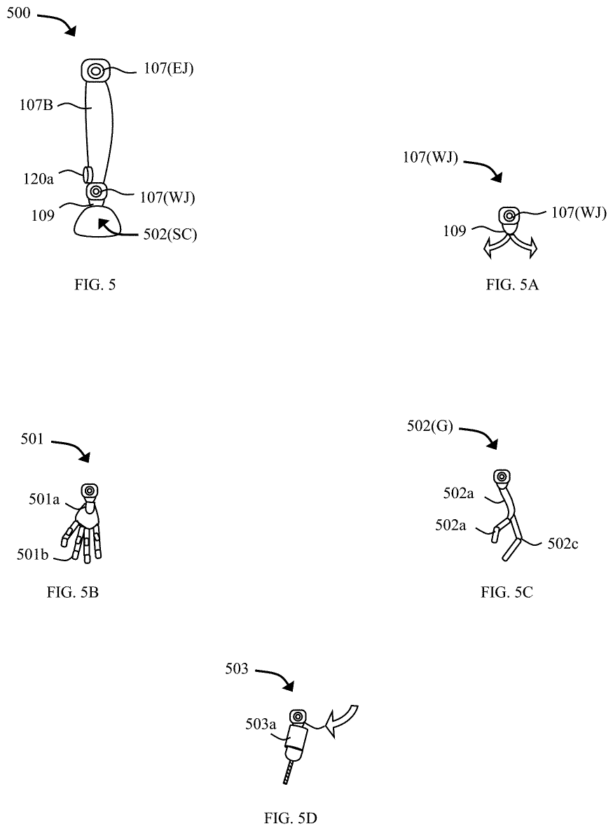

In various embodiments the robot system 100 utilizes one or more robotic omniwheels 103 to achieve self-balance control while traversing through driving environments. In one embodiment the robotic omniwheel 103 comprises an inflated tire 105 mounted about the rim of a hub wheel 104, a drive motor 109 supported by at least one axle rod 110 and at least one hub 111, the hub 111 configured to attach to a yoke module 112 comprising forked arms, and a steering motor 113 to rotate in “yaw” directions, and also the robotic omniwheel 103 comprises a fender 114 which is mounted above the yoke module 113. In one embodiment the robotic omniwheel comprises a motorized track wheel 106 comprising a track belt 107 particularly keyed thereto in axis 108 transversely spaced in relation to the track wheels' drive motor 109, see FIG. 5A.

The robot system 100 having artificial intelligence whereby robots first and second robots 101/102 are configured with at least; a computer operating system 131, a motion control system 132, autonomous drive system 133 comprising LIDAR sensor 134, and an attitude sensing system 135 including attitude state sensors 136, and algorithm 137, a wireless communication system 138, and an electrical control system 139, and also a battery bank with battery charger 140 which are situated on the robot body 119 and wired throughout with USB 115 cable and wiring connections 116, the USB 115 cable can also provide power to electronic components as shown the configurations.

In various embodiments one or more processes for the robot system 100 to statically work during the battery charging process thus to charge a battery bank via the USB 115 communication component. One example of a communication component is a communication port, such as a Universal Serial Bus (USB) port to connect to the robot 101(C) and accordingly to work as a power source to furnish electrical components power and to recharge the lithium battery bank 140 and batteries situated in the legs 126, see FIG. 5B.

In one embodiment the robot 101 is comprising a robot body 119, the robot body having upper section, a torso section comprising a jointed mid-section 129, and a lower section is attached to one robotic omniwheel 103 or attached to two legs 126. The robot body 119 respectively comprising wherein: at least that of a frame 121, an articulated head 122, a neck 123, a plurality of arms 124, and also hand grippers 125 different scenarios apply.

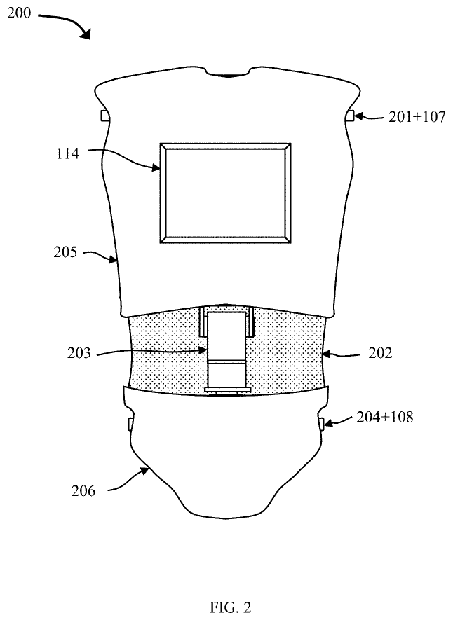

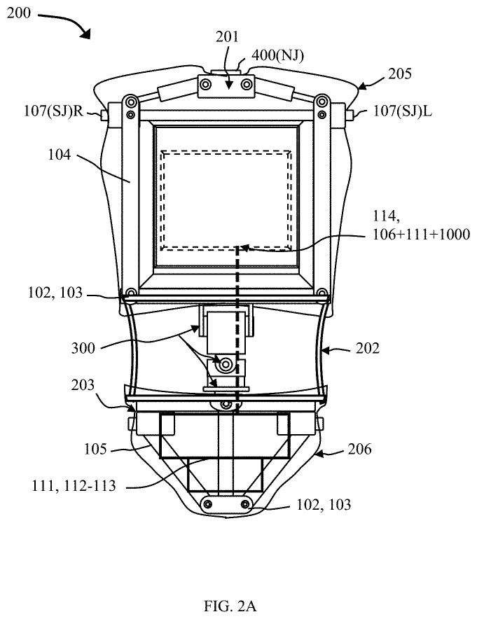

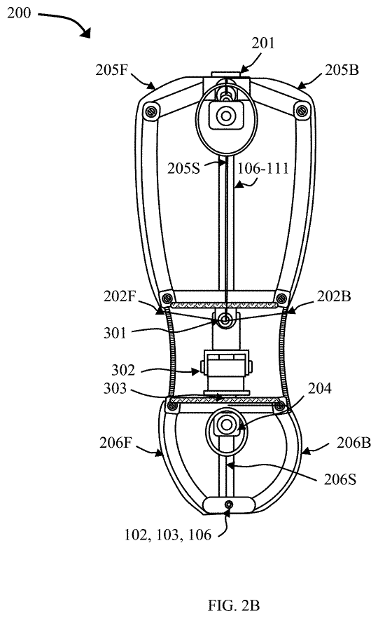

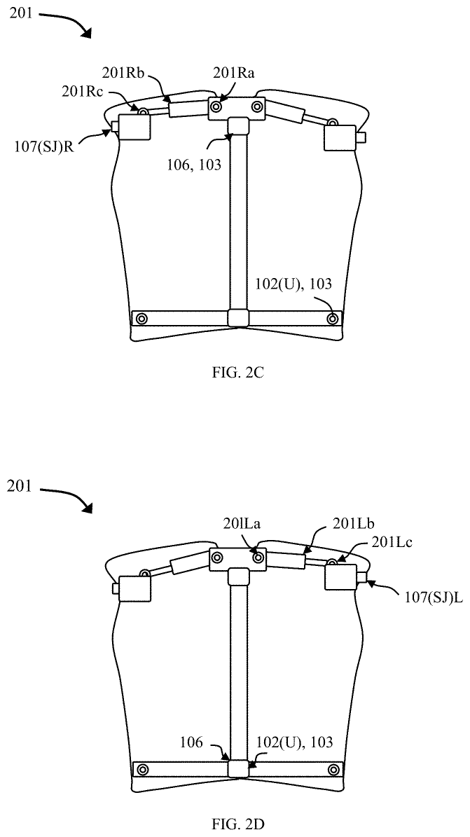

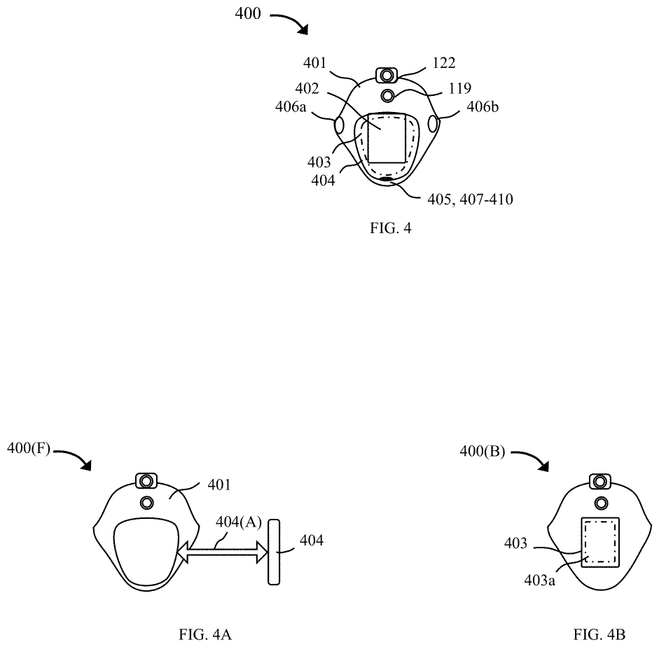

Respectively the robot system's 100 smart service robots are depicted in one or more embodiments the humanoid service robot 101 comprises an articulated head 122 configured with a LED display system 211 and comprising a LIDAR sensor 134 situated at the top. Accordingly,. robot frame 121 via coupling 127 attaches to a neck 123, to the arms 124a, 124b. In FIGS. 1A and 2B the robot base attaches to a robotic omniwheel 103 via coupling 127. In FIGS. 4B and 5B the frame 121 is attached to the leg 121a via coupling 127a and is attached to the leg 121b via coupling 127, and accordingly each leg is attached at the bottom too robotic omniwheel 103a via coupling 127a, and to robotic omniwheel 103b via coupling 127b.

In various embodiments a plethora of actuators 120 for joint motion control comprise: a neck 123 using actuator 120 for 45 degree movement, an arm 124 using actuator 120 for 270 degree rotation at the shoulder, and “elbow” actuators 120 for 90 degree bending, and also “wrist” actuators 120 for 270 degree fore and aft rotation, and also leg 121 actuators 120 for 90 degree rotation at the “knee”, and “ankle” actuators 120 for 45 degree fore and aft rotation.

A method for anthropomorphic motion, sensed by the plurality of control sensors, into a collective set of commands to actuate the plurality of robotic devices, wherein the collective set of commands is functionally equivalent to adaptive autonomous motion, and plausibly a plurality of control sensors can be attached to an operator to monitor the user vital signs, and also sensor coordinated robotic control device converts the user arm and leg motions to be mimicked as robot anthropomorphic motion states. The humanoid robot motion control system to include a collective set of commands with one or more computer systems configured with executable instructions for human or user anthropomorphic motion states and the humanoid robot is to recognized the user actions and body movements and to subsequently copy the user motions.

In one embodiment the robot 101 characterized in that the robot body 119 is configured having self-balancing methodology utilizing the attitude state sensor 136 and a gyro/MEMS, accelerometer 128, or an IMU sensor 173 will be part of a vehicle system and that system will periodically, either from the GPS-DGPS type system or from the PPS, which are not shown, know its exact location, that fact will be used to derive a calibration equation for each device and since other information such as temperature etc. will also be known that parameter can also be part of the equation. The equation can thus be a changing part of the robot system 100 that automatically adjusts to actual experience of the service robot 101 or the robot vehicle 102 in the field. The gyro/MEMS, accelerometer 128, or IMU sensor 173 can be situated on a part of the robot body 119, as well the middle of the robot body.

In one embodiment preferably the middle of the robot body having a motorized disjointed section 129 utilized for bending in various fore and aft shown and for lateral swiveling as shown by arrows 118 via actuators 120, e.g., the disjointed section 129 for fabrication assembly and for maintenance disassembly. The service robot 101 has a generally human-like upright posture and the ability to bend at a midpoint in a manner analogous to a person bending at the waist.

In various embodiments an AC/DC outlet for the robot system 100 to continuously power up, and to work during process using an AC port and DC battery charging system and a AC/DC charging station not shown, and for charging robot on a smart highway system one or more procedures for a mobile robot-drone system utilizing a wireless AC/DC rectenna system to continuously power whilst traveling on the smart highway if the smart highway were to comprise a wireless charging system this process is possible, however the process is not shown.

In one or more embodiments the robot 101 housing compartment 130 can be configured with a user PC monitor 141 which opens as a door for access inside the compartment as shown in FIG. 2A, and in another aspect the compartment can comprise a hinged door 142 which is electrically locking preferable via wireless command. In various embodiments, the mid-section 129, the leg segment 126, or both, include one or more communication components. One example of a communication component is a communication port, such as a Universal Serial Bus (USB) port 115, to allow a person to connect a computing system to the robot system 100. Another example of a communication component is a video display screen different scenarios apply.

In one aspect the PC monitor's 141 video display screen can permit a remote operator to display information, graphics, video, and to incorporate audio speakers 199 and microphones for user interaction with the head system 200 to those near the robot 100. In some embodiments, the video display screen includes a touch screen to allow input from those near the robot 101 different scenarios apply. In one embodiment the heads up display 203 generation logic data can be visually displayed on the heads LED display via the LED system 205 and also on the PC monitor 141, in various embodiments, maps, widgets such as on-screen menus, alternate camera views, and information from sensors and instruments such as from a speedometer, an odometer, and temperature sensors, as exampled for user interfacing.

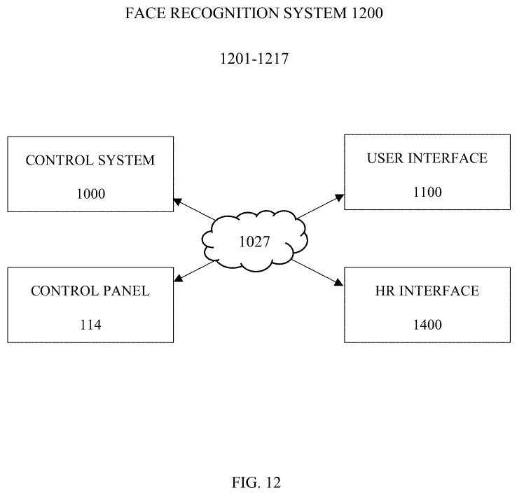

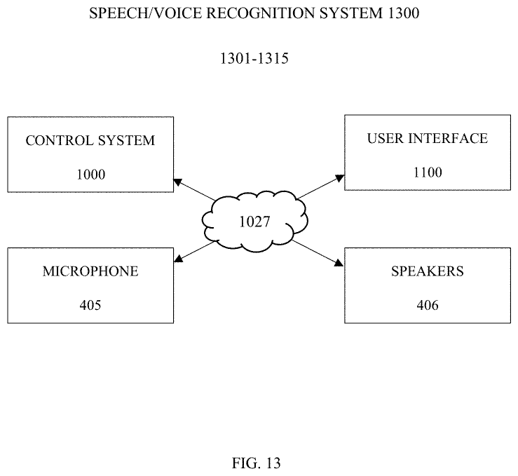

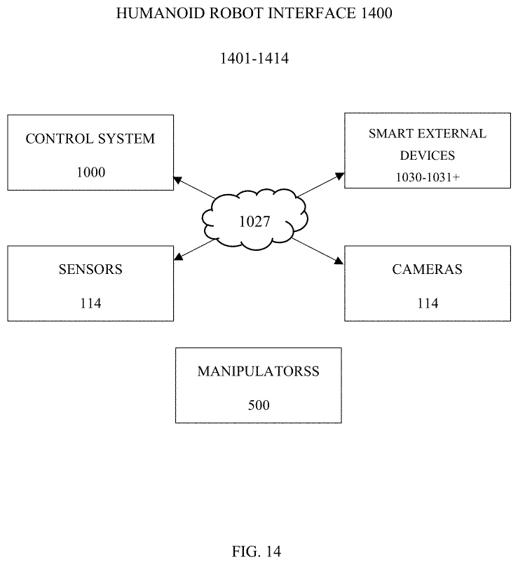

In one embodiment the articulated head 122 (detailed in FIG. 12) may also comprise instrumentation, such as sensors, cameras, microphones and speakers which are not shown, though it will be appreciated that such instrumentation is not limited to the head system 200 and can also be disposed elsewhere on the robot system 100. For instance, the articulated head 122 can include one or more LED illuminators to illuminate the environment. Illuminators can be provided to produce colored illumination such as red, green, and blue, white illumination, and infrared illumination which are not shown, this process is achievable by means of a LED display system 211, FIG. 11.

Referring now in further detail FIG. 1A is a side view of the first service robot 101(A) utilizing a humanoid or respectively an android robot body 119 including at least that of the frame 121 durable fabricated construction comprising at least one robotic omniwheel 103 having an inflated tire 105, and the hub wheel containing 135, 136, and algorithm 137, the head is 122 is comprising a LIDAR sensor 134 and a LIDAR processor 176 set on the highest point, the head 122 also comprises an articulated head system 200, see FIG. 11, and also the robot utilizing various sensors such as an optical sensor 174, video cameras 198, and other sensors, the body 119 is configured with a jointed mid-section 129 for bending, pivoting and balancing functions comprising gyro/MEMS, accelerometer 128 or an IMU sensor 173 which cost effective, and a user PC monitor 141, and the housing compartment 130 is also containing system components 131-133, 138-157, and other robot system components, see FIGS. 7-101.

Referring now in further detail FIG. 1B illustrates the service robot 101(B) utilizing a humanoid or respectively an android robot body 119 including at least that of; the frame 121 attaches body sections together coupling are including; the neck coupling 127(N), the upper arms having shoulder couplings 127(S) and the arms also comprising elbow couplings 127(E) and wrist couplings 127(W), and also the frame 121 attaches the upper body to the lower body via mid-section coupling 127(MS), the frame also attaches one jointed leg connecting to a rounded hip joint for bending forward, the hip coupling 127(H) is attached to the leg which comprises one knee coupling 127(K), and one ankle coupling 127(A).

Referring now in further detail FIG. 1C is a side view shows the second service robot vehicle 102 comprising one robotic omniwheel, the robotic omniwheel 103 comprising an attitude sensing system 135 and attitude state sensor 136 controlled by algorithm 137, the robot vehicle 102 comprising a sensory system 154 including at least one LIDAR sensor 134 managed by a LIDAR processor 176 set on the highest point of the cargo container 143, as well as the vehicle comprising video cameras 198. The robot vehicle chassis 144 is configured with a centralized axle 145 for supporting the weight of cargo, and the robot system components 131-133, 138-157 are housed in a compartment 130 situated on the chassis 144, suitably function processes and control system components are disclosed in FIGS. 7-12, various scenarios apply as discussed hereafter.

In one embodiment the robotic omniwheel comprising a drive motor 109 (preferably an electric hub motor) is enclosed in the body of a hub wheel 104, accordingly hub wheel's assembly having linear motion perpendicular to the axis 108 of rotation and parallel to the gravity line or least closing an oblique angle with the gravity line.

The robotic omniwheel 103 is configured with a yoke module 112 along with at least one hub 111 having lug nut and bolt shown by arrows 118(LB) which supports the hub wheel 104 securely. In one embodiment the yoke module is attached to the hub wheel 104 assembly respectively the connection spaced from the axis 108 of rotation of the hub wheel 104.

In one aspect the self-balancing function of the robotic omniwheel 103 is configured with a motor controller 117 and an attitude state sensor 136, respectively the motor controller 117 and the attitude state sensor 136 and the attitude sensing system 135 are contained within the “inner circumference” of the hub wheel as shown by arrow 118(IC), and furthermore the motor controller 117 is configured to automatically adjust the attitude sensing system 135 and direction of the electric drive motor 109 to reduce a difference between a pitch measured by the attitude sensing system 135 and a zero pitch set point, wherein the attitude sensing system 135 also comprising algorithm 137 to provide a selectable variable braking input to the motor controller 117 (brake not shown), and in one aspect a parked mode (not shown) in which the robot body 119 is rotated about the axis 108 of the robotic omniwheel such that self-balancing resists lateral toppling of the service robot 101 and the robot vehicle 102. The attitude sensing system 135 is also situated in the frame 121 of the robot and is inner-connected to other attitude state sensors 136 via USB power cable 115 connections, see FIGS. 2A, 3A and 3B, 4A and 5A.

In further detail FIG. 2A is a front see through view of the robotic omniwheel discloses the hub wheel 104 encompassed with an inflated tire 105 is configured with a drive motor 109 enclosed in the body of hub wheel 104 having vertical rotation perpendicular to axis 108, the motorized hub wheel 104 is rotably mounted on at least one axle rod 110 and that of hub 111a, 111b are configured to attach thereon a forked yoke module 112, the yoke module 112 configured for supporting the motorized hub wheel 104 on axis 108, the motorized hub wheel's drive motor 109 by means of the prewired yoke module 112 allowing the electric control system to shunt electrical power directly to the drive motor 109 via USB 115 power cable method.

In one aspect the yoke hollow conduit is containing a gyro/MEMS, accelerometer 128 or IMU sensor 173 is to detect when the yoke is not balanced during this process the motion control system 133 detects the off balance and accordingly adjustments to remain self-balanced is achieved by the attitude sensing system 135 essentially, the robotic omniwheel 103 is configured with a motor controller 117 and the attitude sensing system 135 and the attitude state sensor 136, respectively the attitude state sensor 136 and the attitude sensing system 135 are contained within the “inner circumference” of the hub wheel as shown by arrow 118(IC), and furthermore the motor controller 117 is configured to automatically adjust the attitude sensing system 135 and direction of the electric drive motor 109 to reduce a difference between a pitch measured by the attitude sensing system 135 and a zero pitch set point.

In one embodiment the upper yoke section is 112 is coupled by mechanically attaching onto the robot's frame 121, during this process the upper end the USB 115 power cable and the electrical wire connections 116 will successively connect to the robot system 100 electric control system 139 and control components 131-133.

Referring now in further detail FIG. 2B showing front view of a first service robot 101(A) characterized in that of a uni-wheeled service robot comprising a humanoid robot platform comprising wherein: at least that of a frame 121 supporting the robot's neck 123 and the robots articulated head 122 which comprises a detachable crown section for accessing the LIDAR sensor 134, and the LIDAR processor 176. The head lower section wherein is comprising the articulated head system 200. The robot body 119 configured with video cameras 198 a PC monitor 141, with a heads up display 202 via the articulated head system 200 and the Internet 194.

In one embodiment the robots articulated head 122 is supported by the neck 123 which is comprising actuator 120, and the arms 124a and 124b comprising shoulder and elbow actuators 120, and hands 125a and 125b comprising wrist actuators 120.

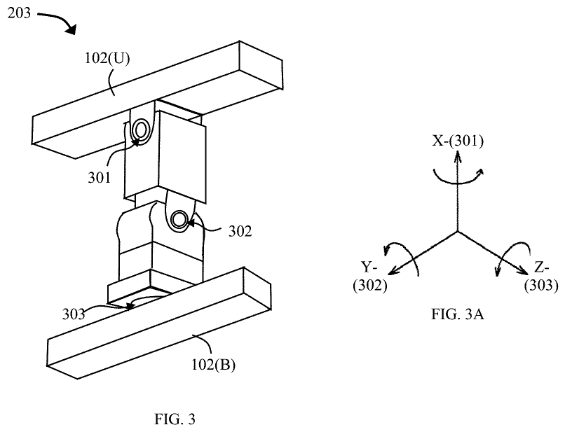

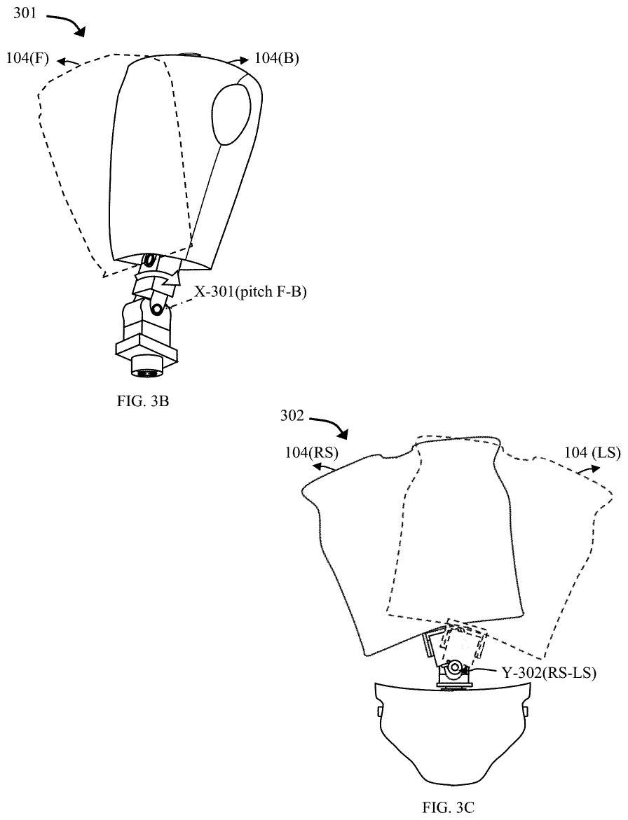

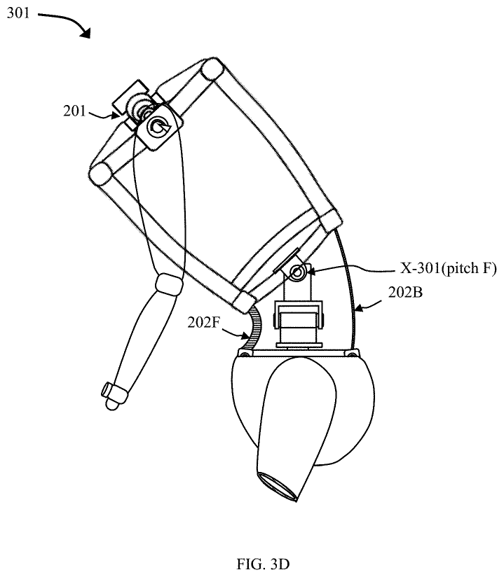

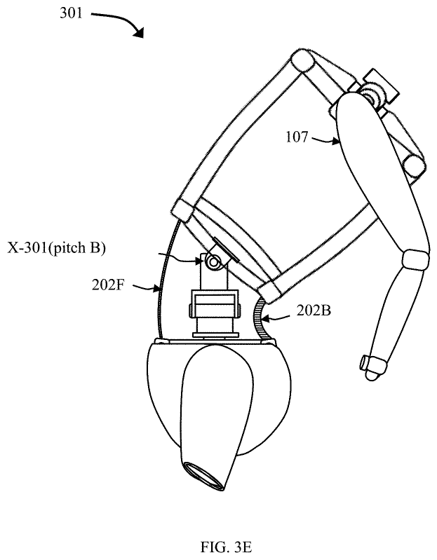

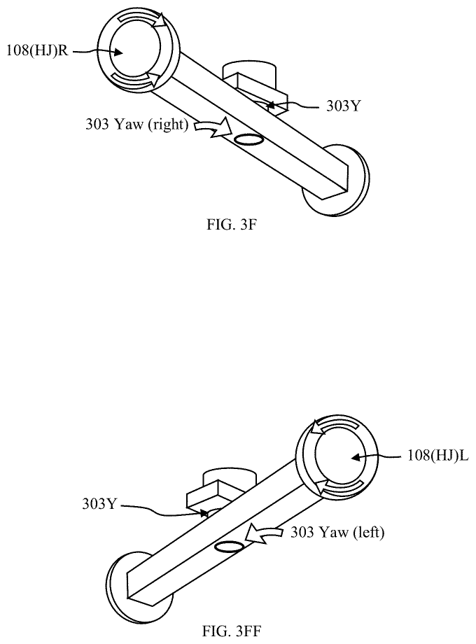

In one embodiment the a self-balance process 157 is configured to utilize a gyro/MEMS, accelerometer 128 or IMU sensor 173 is situated in the middle of the robot body 119, and the middle of the robot body preferably having a motorized disjointed section 129 utilized for bending in various fore and aft shown and for lateral swiveling via actuators 120, (e.g., the disjointed section 129 is utilized for bending in various fore and aft directions and for lateral swiveling action) for balance control, see FIG. 3A and FIG. 3B.

In various embodiments and also the housing compartment 130 is comprising robot system components such as the motor controller 117, and systems 131-133, and interface processes 175-185 respectively, the system processes are detailed further in FIGS. 7-10.

In one embodiment the base the robot body 119 is configured with a single robotic omniwheel 103 having an inflated tire and as shown the yoke module's 112 steering motor 113 control by means of the motor controller 117. Respectively the robotic omniwheel 103 is attached to the base of the robot body by the coupling 127 e.g., the process is achieved mechanically. The robotic omniwheel is controlled by the attitude sensing system 135 including a the attitude state sensor 136, and algorithm 137 the attitude state sensor 136 is placed in the robotic omniwheel motorized wheel and/or the robot body respectively, the motion control system 132 receives a signal from the attitude state sensors 136 and then issues control instructions via motion control system procedures to balance the robot (e.g., procedure process is detailed more in the following paragraphs).

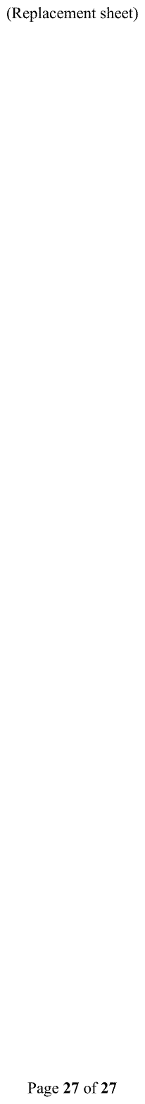

In one aspect the attitude state sensor 136 is placed inside the robot body 119 in this process of the service robot 101(A) allows the service robot to uniquely travel when indoors, and perceiving the service robot 101(A) can travel at high speeds on roadways such as a smart highway, these actions are perception-ally shown in FIG. 13.

Referring now in further detail FIG. 3A and FIG. 3B the see through drawings of robot 101 embodiments, as shown in FIG. 3A the service robot 101(A) having a self-balancing body 119 comprising at least that of; an articulated head 122 comprising a head system 200 and the LIDAR sensor 134, a neck 123 an autonomous drive system 133, an attitude sensing system 135 including sensor 136, and algorithm 137, arms 124 with hands 125 or grippers, the arms are configured with actuators 120, and mid-section is configured with a balance process method utilizing a gyro/MEMS, accelerometer 128 or a IMU sensor 173, a computer operating system 131, a motion control system 132, a wireless communication system 138, and also the electrical control system 139 with wiring connections 116, and also a battery bank with battery charger 140 which are situated on the lower part of the robot body and the base of the robot is comprising the yoke attached to the lower base shown by arrow 118(RLB) along with one robotic omniwheel 103 attached thereon which is comprising an inflated tire 105. Accordingly the robot body can comprise LED lights including signal lamps, indicator lamps, and brake lamps not shown, different access scenarios apply, and accordingly the robots fabrication process is completed by the manufacturer.

As shown in 3B the front see through side view of robot 101(A) comprising at least that of; an articulated head 122 comprising the LIDAR 134, the attitude sensing system 135 including attitude state sensor 136, and algorithm 137, arms 124 with hands 125 plus coupling 127, the robot body 119 configured with actuators 120 and bending mid-section 129 respectively configured with a balance process method utilizing a gyro/MEMS, accelerometer 128 or IMU sensor 173 and the arms configured to assist the attitude sensing system 135 as shown by arrow 144(AS), the robot configured with algorithm 137 set point other than zero as directed by the computer operating system 131 and the motion control system 132. The electrical control system 139 and battery bank with battery charger 140 are situated on the lower part of the robot body and the base of the robot. The robotic omniwheel's yoke module 112 shown by arrow as 118(SBYM) the robotic omniwheel is supported by the hub 111 with lug nut and bolts.

In further detail FIG. 4A shows a side view of the robotic omniwheel 103 comprising an inflated tire 105 and a fender 114 and the robotic omniwheel is the couple the yoke motor onto the base of the robot body frame 121 as shown by arrow 118(SM) and the steering motor is comprising the USB 115 cable and wiring connections 116 subsequently are connected to all robot system components via an assembly means.

In one embodiment the yoke steering is configured to contain USB 115 power cable and wired connections wherein the USB 115 power cable connects to the yoke motor 113. The yoke module is configured to steer the motorized hub wheel 104 by means of said steering motor 113. In one aspect the yoke's upper section is coupled onto the lower section of the yoke steering motor 113, and in another aspect the steering motor's upper section is mechanically attached onto the base of robot's lower body via a coupling 127 mechanical means, (not shown).

Referring now in further detail FIG. 4B a front view showing a first robot also characterized in that of a service robot 101(B). In various aspects the motion control system and the wireless control system and the user utilizing wireless control system devices control the service robot 101(BB) and the robotic omniwheel operations. Respectively the service robot 101(B) utilizing a robot body 119 including at least that of the frame 121 attaches body sections together coupling are including; the neck coupling 127(N), the upper arms having shoulder couplings 127(S) and the arms also comprising elbow couplings 127(E) and wrist couplings 127(W), and also the frame 121 attaches the upper body to the lower body via mid-section coupling 127(MS), the frame also attaches one jointed leg connecting to a rounded hip joint for bending forward, the hip coupling 127(H) is attached to the leg which comprises one knee coupling 127(K), and one ankle coupling 127(A). The leg embodiment comprises a power system for charging a battery pack which is illustrated and described FIG. 5B.

In one embodiment of service robot 101(B) a cantilevered yoke with a curved shaped arm is to support the robotic omniwheel, the robotic omniwheel is affixed to the hub assembly.

In one embodiment of service robot 101(B) the robotic omniwheel is configured with a cantilevered yoke motor 113 to steering the robot.

In one embodiment of service robot 101(B) the robotic omniwheel can be configured to tilt and rock by means of the one ankle (e.g., the ankle is jointed to pitch forward and backward).

In one embodiment of service robot 101(B) the robotic omniwheel is controlled by means of the self-balancing robot system comprising the self-balancing process 157 managed by at least that of the computer operating system 131, the motion control system 132 and the autonomous drive system 133 comprising a LIDAR sensor 134 with complex processes detailed in the following processes, and the attitude sensing system 135 including the attitude state sensor 136, and algorithm 137 processes, and also wireless communication system 138 and processes, electrical process by means of the electrical control system 139, and by and wireless control system devices control by the user.

Referring now in further detail FIG. 4C a front view showing a first robot also characterized in that of a service robot 101(BB). In various aspects the motion control system and the wireless control system and the user utilizing wireless control system devices control the service robot 101(BB) and the robotic omniwheel operations. Respectively the service robot 101(BB) is also utilizing a robot body 119 including at least that of; the frame 121 attaches body sections together coupling are including; the neck coupling 127(N), the upper arms having shoulder couplings(S) and the arms also comprising elbow couplings 127(E) and wrist couplings 127(W), and also the frame 121 attaches the upper body to the lower body via mid-section coupling 127(MS), the frame also attaches the upper legs to the hip couplings 127(H), and the legs also comprising knee couplings 127(K), and ankle couplings 127(A) accordingly attach to the robotic omniwheel's yoke motor 113, and respectively all aforementioned couplings 127 are connected via a mechanical means, (not shown). The service robot 101(BB) leg components comprise a power system for charging a battery pack which is illustrated and described FIG. 5B.

In one aspect the humanoid robot platform of service robot 101(BB) is capable of traverse biped walking and capable of traverse achieving skating motions whereby the robot body 119 configured with a self-balance process 157 utilizing a gyro/MEMS, accelerometer 128 or IMU sensor 173 is situated in the middle of the robot body 119. The self-balancing robot system comprises a self-balancing process 157 managed by at least that of: the computer operating system 131, the motion control system 132 and the autonomous drive system 133 comprising a LIDAR sensor 134 with complex processes detailed in the following processes, and the attitude sensing system 135 including the attitude state sensor 136, and algorithm 137 processes, and also wireless communication system 138 and processes, electrical process by means of the electrical control system 139, a battery bank with battery charger 140 which is further detailed see FIGS. 7-10.

In one embodiment the robot body 119 is configured to situate the computer operating system 131, the motion control system 132 and the autonomous drive system 133 in each upper leg section, thereby the light weight components set in the upper leg section addresses top heavy issues, and accordingly the electrical control system 139 and battery bank with battery charger 140 can be situated in the mid-section of the robot body 119 thereby the weight of the battery is thusly supported by the bionic like legs for additional strength.

In one aspect the motorized disjointed section 129 is utilized for bending in various fore and aft directions, for lateral balancing, for leaning sideways, and for swiveling circulation via electronic actuators 120 which are mechanically assembled the degree of bending, leaning and swiveling is calculated by the motion control system 132 e.g., different calculations apply.

In one embodiment the robot body 119 is configured with jointed upper leg 126 sections working as hips connecting to the mid-section 129 accordingly the top leg portion comprising actuators 120(H) to rotate fore and aft to lift leg upward and the downward for achieving biped walking motion and also the knee section joint actuator 120(K) comprise actuators 120 to engage biped motion, and as well the bottom leg 126 working as an ankle joint using 120(A) connecting the robotic omniwheel 103a and 103b in this process the robot 101 can travel by gliding and skating or walking when indoors perceivably, these actions are not shown.

Referring now in further detail FIG. 5A shows a cut through view of the robotic omni-directional track wheel 107 supported by a yoke module 112 respectively the USB power cable 115 and the wire connection 116 are situated inside the hollow housing of the yoke module 112. The yoke module is also housing the MEMS, accelerometer 138 or IMU sensor 173 for balance control. The motorized track wheel 106 comprising a track belt 107 particularly, there is shown the forward drive motor 109 having sprocket wheels as shown by arrows 118(SW) and keyed thereto in axis transversely spaced in relation to a center axle rod 110 and that of a hub 111, the hub 111 configured to attach thereon to the yoke module 112. In more detail the track belt 107 section is formed of metal with an outer peripheral edge formed of a high friction and resilient material with sprocket teeth formed on the outer periphery of the sprocket wheels driving connection, the sprocket wheels having perforations along each edge of a track belt 107 as shown by arrows with circular metal plates supporting and strengthening the opposing side walls of the track belt 107.

Referring now in further detail FIG. 5B shows a first service robot 101(C) also having a humanoid robot platform however the robot configured with the following configurations: the LIDAR 134, and contrivances including and neck 123, arms 124a and 124b comprising actuators 120a and 120b, and hands 125a and 25b comprising actuators 120a and 120b, and leg 126a including coupling 127a, and also leg 126b including coupling 127b, accordingly the coupling 127a is configured to attach a left robotic omnidirectional track wheel 107a on the bottom leg section, and also accordingly the coupling 127b is configured to attach a right robotic omnidirectional track wheel 107b on the bottom leg section. The robot 101(T) is comprising two legs; leg 126a and leg 126b capable of a bi-ped motion and configured for traverse biped walking, rolling and skating motions.

In one embodiment the service robot 101(C) wherein the housing has to be installed on an obstacle is detected around the robot in order the wireless sensor node (not shown) for an inductive charging to the lithium battery or battery bank 140 (different scenarios apply) located in each of service robot 101(C) legs 126, and the wireless sensor node is mounted in the battery bank 140 respectively via means of a magnetic masking layer (not shown) in the electrical control system 139 comprises a microelectromechanical system (MEMS) device 128 or IMU sensor 173 for the conversion of ambient mechanical vibration into electrical energy through the use of a variable capacitor is located inside the track wheel to recharge batteries, the process is as follows a wireless microprocessor 185 controls the provision of power to an A/D converter power to store the ambient vibrational electrical energy in the batteries 140.

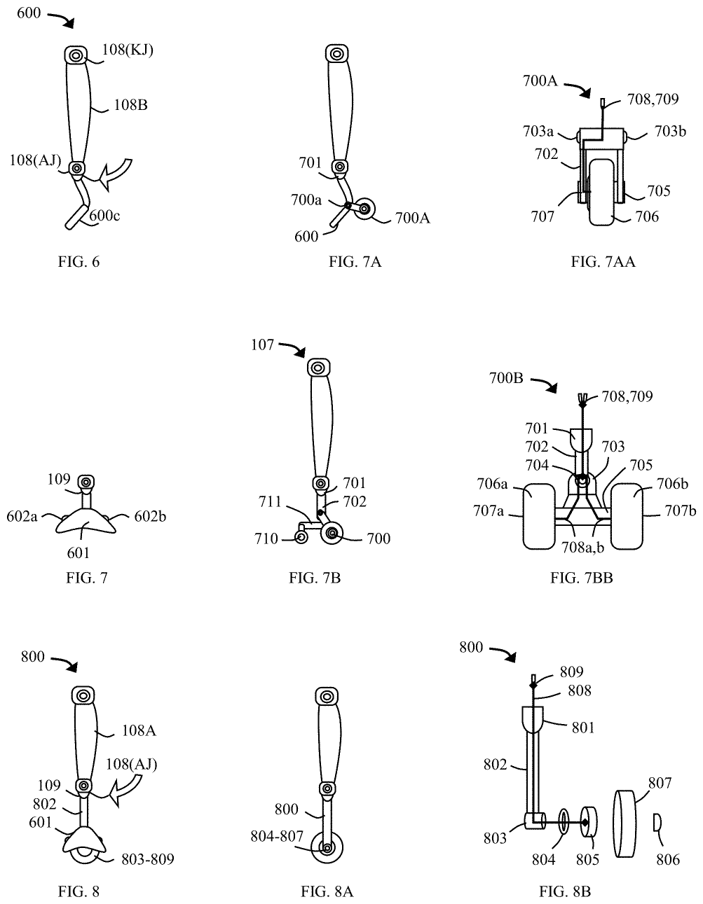

Referring now in more detail FIG. 6A showing a front view of the second service robot vehicle 102(A) of FIG. 1A, the robot vehicle platform is uniquely configured with a vehicle body 119 having a chassis 144 configured to utilize one “uni-robotic omniwheel, respectively the robot 102(A) robot body 119 is configured to be sleek and aerodynamic whereby the chassis 144 and the uni-robotic omniwheel having linear motion perpendicular to the axis 108 of rotation and parallel to the gravity line. The robot body 119 is comprising other body cavities which can be accessed by secondary doors with locking method, not shown.

Respectively second robots 102 utilize a modular body for service vehicle applications and robot vehicles 102(A), 102(B) see FIG. 5B, and 102(C) see FIG. 13. Accordingly having sections this fabrication process is achieved by the manufacturer. As well, various robot system components are situated accordingly during the fabrication process, and as well the container can be is configured with other doors and also the container can comprise LED lights including signal lamps, indicator lamps, and brake lamps not shown, different lighting accessories and scenarios apply.

In one aspect the size of the container is configured to carry goods within, the goods can be loaded by humans or by autonomous pallets, and fork lifts, the methodology is not shown.

In various embodiments detailed in the robot vehicle 102(A) wherein embodiments utilize one or more robotic omniwheels 103 having a fender 114 and an inflated tire 105, and accordingly the vehicle body 119 is to connect to the chassis 144 via a coupling 127.

In one embodiment the robot vehicle 102(A) respectively is comprising a cargo container 143 configured for housing cargo objects, can utilize a roll top door 144 which is electrically locking and the robot vehicle 102 also utilizing a chassis 144 and a centralized axle 145 supporting the robotic omniwheel 103, different scenarios apply.

In one embodiment the robot body 119 having a chassis 144 configured to support the weight of the payload (not shown) contained within a cargo container 143 accordingly, the cargo container 143 is situated above the primary housing compartment 130, and respectively the housing compartment 130 contains where; the computer operating system 131, the motion control system 132, the wireless communication system 138, the autonomous drive system 133, the attitude sensing system 135, and the electrical control system 139 including wiring connections 116 and USB 115 power cable, and also the battery bank with battery charger 140. In one embodiment the cargo container 143 is configured with a hinged door 142 with digital locking mechanism, not shown. The service robot vehicle 102(A) functions and processes are detailed further in FIGS. 7-10.

Referring now in further detail FIG. 6B showing front or a rear view of a second service robot vehicle 102(B) is also characterized in that of a robot vehicle platform configured with a vehicle body 119 configured with at least two robotic omniwheels 103 having a fender 114 comprising the self-balancing 157 process. In one embodiment the robot vehicle 102(B) is configured to operate as a self-balancing via process 157, the chassis 144 comprises a dual axle having rotation perpendicular to axis, whereby the axle 110 is configured to attach the robotic omniwheel 103 at the most centralized point for maximum balance control.

Furthermore service robot vehicle 102(B) is comprising methods to furnish power to various actuators, gyro/MEMS, accelerometer 120 or IMU sensor 173 and to other motorized, contrivances, and the robotic omniwheel 103 drive motor is configured for handling high velocity speed levels to travel on common roadways and on smart highways, respectively control processes are detailed further in FIGS. 7-10.

Furthermore service robot vehicle 102(B) is comprising methods autonomous control sensors such as LIDAR 134 can be set on the roof top as shown, and a plethora of sensors e.g., listed from a sensory system 154, and accordingly a variety sensors are situated throughout the chassis and body to detect obstacles and to perceive physical features of the environment.

In one embodiment service robot vehicle 102(B) is fabricated by the manufacturer to comprise a chassis 144 and a cargo container 143. The chassis 144 comprises wherein dual axles a left axle 145a and a right axle 145b. Respectively robotic omniwheel 103a is coupled to left axle 145a via coupling 127a, and robotic omniwheel 103b is coupled to right axle 145b via coupling 127b.

In one aspect the size of the container is configured to be a similar to that of a common pallet, the cargo pallet is be loaded by larger sized autonomous fork lifts, the methodology is not shown.

In one embodiment aspects service robot vehicle 102(B) is comprising a power control system including a plurality of high-voltage rechargeable lithium-ion-based batteries.

In various embodiments the service robot vehicle 102(B) comprising wireless communication, cameras, LIDAR sensors and location sensors, and a computer control system and other aforementioned system and process functions to manage one or more autonomous cargo loading operations as disclosed herein.

In various aspects the service robot vehicle 102(B) is to be loaded at a consignment location, not shown, and the service robot vehicle 102(B) is configured with a method to read and interpret visual codes that encode the at the location and other associated data as fiducials to determine loading process.

In various aspects the service robot vehicle 102(B) is configured to coordinate material handling equipment via the wireless communication system 138 which is used to interact with and control a number of robotic pallets to transport the cargo up ramps to access the inside container.

In various aspects the service robot vehicle 102(B) is configured to coordinate material handling equipment via the wireless communication system 138 which is used to interact with the material handling crew.

In various aspects the service robot vehicle 102(B) is configured to coordinate material handling equipment via the wireless communication system 138 which is used to interact with autonomous drones (not shown) which can be configured to wirelessly collaborate as peers respectively assisting one another in the loading and unloading process of service robot vehicle 102(B).

In various aspects the service robot vehicle 102(B) is configured with a method to read and interpret visual codes via a scanning system, not shown.

In various aspects the service robot vehicle 102(B) is configured with one or more methods of enabling one cargo load to be delivered in a single delivery mission, or a plurality of cargo loads to be delivered in more the one mission; a method of enabling the plurality of cargo loads being loaded at a starting location, the method comprising acts of to travel from a starting location to a first delivery location; to second delivery location, and to the at the final location to recharge, to refuel, and maintenance and the loading process repeats.

Primarily, the service robots (A), (B), and (C) and service robot vehicles 102(A), 102(B) and also the a third robot vehicle 102(C) shown in FIG. 13 comprise autonomous drive methods configured for traveling on a smart highway 158, the autonomous driving process is detailed further in the following paragraphs.

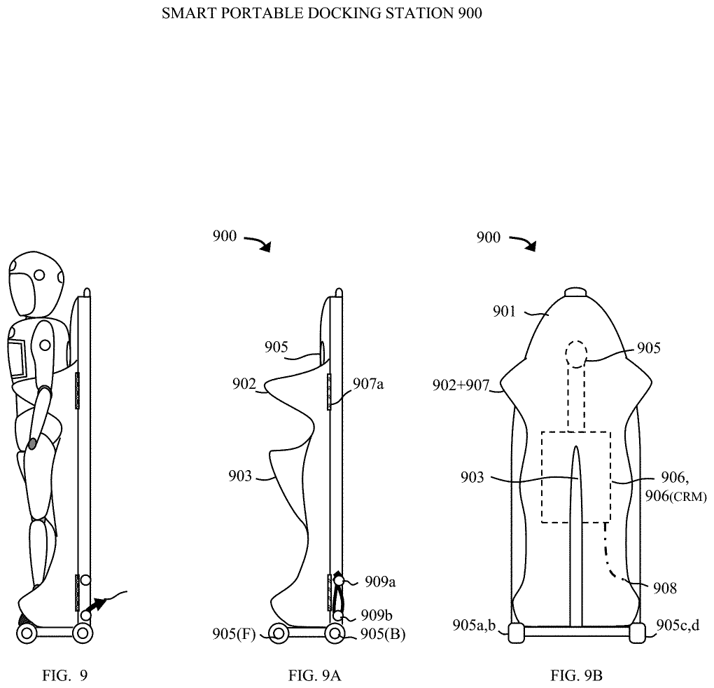

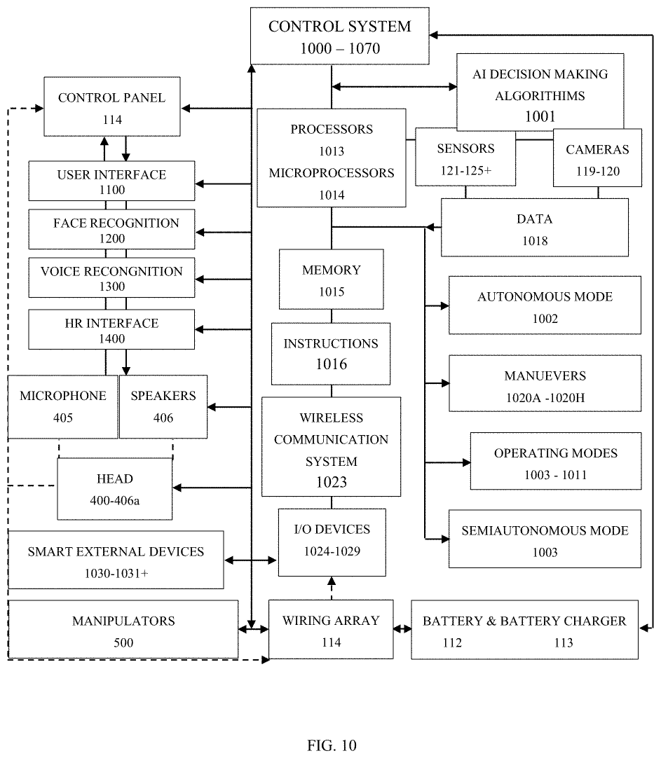

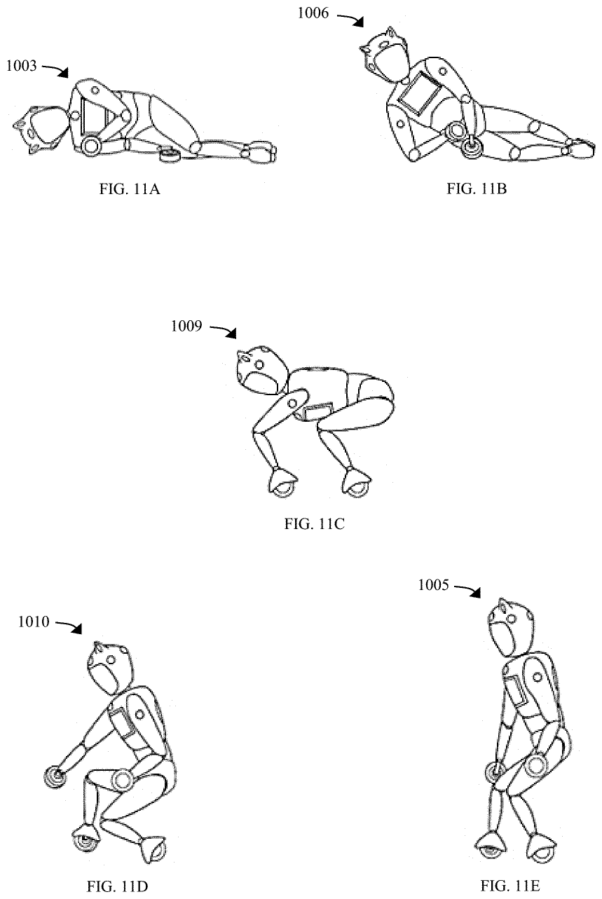

In further detail FIG. 7, FIG. 8, FIG. 9, FIG. 10, FIG. 11 and configure-ably the head system 200 of FIG. 12, the self-balancing robot system 100 comprising the following control system and communication methodologies to manage the service robot's and robot vehicles by means of the computer operating system 131, the motion control system 132 for controlling the self-balancing system processes 157 detailed herein.

i) an inclination sensor arranged to detect a state of inclination of the distance measuring sensor; and gyroscope/MEM sensors, an accelerometer or IMU sensor 173 for self-balancing event, sensor array including; a micro-electro-magnetometer system or “MEMS” also a gyroscopic unit to compensate a certain number of disturbances induced by said robot module itself (high currents circulating in the conductors, the servo motors, leg actuators, grippers etc.), and by a GPS circuit also incorporated within the frame and body GPS is not shown.

ii) one or more implement sensors are non-ionizing radiation sensors, IR sensors not shown, and others.

iii) the omniwheel device further comprises an on-board motion sensor.

iv) the omniwheel device further comprises: a position locating sensor, the device further comprises an on-board wireless transmitter.

v) the robot and omniwheel devices further comprises an on-board temperature sensor.

vi) USB 115 cable and plug connectors, and so forth.

Drive system an infrastructure logic arrangement for the drone and robot array including; microprocessors, environment detection LIDAR 134, control and combine the real-time data with existing data sets and social network feeds, wherein the one or more sensors include one or more of the following: one or more proprioceptive sensors to sense position, orientation and speed of the robot module.

vii) one or more accelerometers, one or more tilt sensors, one or more force sensors, one or more position sensors, one or more infrared sensors, one or more ultrasonic sensors and perimeter sensoring methods.

viii) one or more speed sensors, wherein the one or more sensors are adapted to provide one or more of omnidirectional imaging and thermal imaging, wherein the hybrid drone/robot is associated with one or more of the following: autonomous technology, robotics, predictive analytics, autonomous operation, semi-autonomous operation, machine learning, and machine-to-machine communications.

ix) the robot-drone hybrid system for indoor or outdoor event platforms comprising: simultaneous Localization and Mapping (SLAM) generates real time, has been attracting attention in the technical field of the autonomous moving robot. In the SLAM technique, the autonomous motion includes a distance measuring sensor such as, but not limited to, a Laser Range Finder (LRF), not shown, for event task; the robot work with other peer robots and for other event tasking such as; strategic materials handling, delivery, recovery, and also for scientific research to gather element samples.

In one embodiment using SLAM (Simultaneous Localization and Mapping, Real Time Simultaneous Localization and Mapping) algorithm for three-dimensional patterning; through digital compass where the relative coordinates that the peer to peer system of the robot system 100, turned in azimuth patterns as peer robots follow one another in parallel alignment as shown in FIG. 13.

The development of these sensor technology makes the robot more intelligent, more and more functions can be realized. But the navigation of the robot is still one of the key and difficult issues, because it is a prerequisite for the robot to complete obstacle avoidance, detection and other unknown environmental tasks.

The service robots 101/102 are multifunctional service robots characterized in that the robot body is containing the communication port which can include at least; a USB to TTL UART port, I2C interface, Bluetooth interface and 6Pin GPIO port, tablet PCs with Bluetooth interface to establish a Bluetooth connection, and accordingly the radio-frequency signals can be configured to receive information associated with the operation of the robot body and of the robotic omniwheel 103 from the computing device 170 and the wireless communications system 138 and other related devices.

In FIG. 7 a diagram flowchart showing the robot system 100 control systems including the computer operating system 131 managing operations of at least: the motion control system 132 detailed in FIG. 8; the autonomous drive system 133 detailed in FIG. 9; the wireless communication system 138 detailed in FIG. 10; and the I/O Interface 146 detailed in FIG. 11.

Respectively self-balancing robot system 100 service robot's 101 and robot vehicles 102 utilize the motion control system 132 for controlling the robotic omniwheel 103 inertia process; the drive motor 109 and the steering motor 113 torque, yaw and pitch momentum is calculated by the computer operating system 131 processors 147 receiving sensory system 154 data information and motor controller processors 155 immediately carry out instructions communicated by the motion control system 132.

In FIG. 8, a schematic process of the motion control system 132 configured to control traverse motion and holonomic motion e.g., can turn more than 360 degrees—full circle without any obstacle, and also to achieve level balance by means the self-balancing system 157 using the attitude sensing system 135 and state sensor 136 situated on the robotic omniwheel hub wheel 104 and also the attitude sensing system 135 and state sensor 136 placed in the robot body 119. The attitude sensing system 135 and attitude state sensor 136 and algorithm 137 e.g., pre-calculated by the algorithm 137 configured by the computer operating system 131, for the most part the attitude sensing system 135 is configured for continuously measuring and delivering the instantaneous balance control and for continuously measuring and delivering the instantaneous pitch .phi. and roll .phi. .sub. .tau. angle values.

In further detail FIG. 8 the motion control system 132 methodologies include at least: 801. The processors 147 communicate a memory configured to store programming instructions 149, and the processor configured to execute the programming instructions for the robot 101 and the robot 102; 802. The processor 176 to read and interpret LIDAR 134 codes that encode robot 101/102 location and associated data 150 as fiducials to determine sensory system 154 information and store the data in memory 148; 803. A process to receive navigation information from a satellite modem 191 configured to receive a satellite signal and to communicate the data information 150 to the robot 101 and the robot 102 via signal inputs 156; 804. A process to receive map data information from one or more GPS satellites 194; via GPS interface 184; 805. A process to receive image data from an IMU sensor 173, optical sensor 174, and sensory sensor 154 configured to capture around the robot 101 and the robot 102; 806. A process to receive distance information from a distance sensor configured to sense objects positioned around the robot 101 and the robot 102; 807. A process to determine a fusion method for information measured by the image sensor and the distance sensor based on a receiving state of the satellite navigation receiver and precision of the map data to recognize the driving environment of the robot 101 and the robot 102; 808. A process to determine a reception strength of the navigation information and to determine a precision level of the GPS mapping data of the robot 101 and the robot 102; 809. A process to extract from an object and from information measured by the LIDAR sensor 134 and the attitude sensory system 135, and the information extracted from the gyro/MEMS, accelerometers 128 used to recognize irregular balance when driving through environments and recognize forced off balance from impact; 810. A process of the smart highway robot system 100 in real time, respectively to provide positioning information associated with a current location of robot 101 and of robot 102, and the positioning system 160 gathers the information via smart highway tags 161. A process to engage power ON to drive through environment and a process calibrate mapping path to drive and to autonomously self-dock to charge, and subsequently shut OFF power, whereby in one embodiment the motion control system 132 selects processes select a switch to power on motor controllers 117 to work, and in another embodiment the motion control system 132 selects a switch to turn power off motor controllers 117 to stop working.

In one aspect the attitude sensing system 135 configured with the control algorithm 137 is configured for sensing the balance of the robot 101/102, the control algorithm 137 pre-calculated by the computer operating system 131 configured for establishing the robotic omniwheel 103 direction required for balancing and amount of travel along the direction required for balancing; wherein the robotic omniwheel 103 is operatively configured to turn to a direction required for balancing and travel the amount in the direction required for balancing as to self-balance the robot 102 and to self-balance the robotic omniwheel 103.

In one embodiment the robotic omniwheel 103 configured to have a direction of travel (W) and a turning angle (.THETA.) between the robotic omniwheel 103 direction of travel and the fore direction, the robotic omniwheel drive motor 109 operatively configured to rotate the robotic omniwheel 103 and move the robot 102 traversely forward or backward in the robotic omniwheel direction of travel; the computer operating system 131, the motion control system 132, and the electrical control system 139 are configured for establishing a balancing robotic omniwheel 103 direction required for adjusting the robots level balance from range of power provided. The motion control system 132 establishes a balancing amount of travel along said balancing direction required for adjusting the robots 102 balance; where said robotic omniwheel 103 is operatively configured to: (i) turn to the robot 102 direction (W), (ii) travel the balancing amount of travel (.OMEGA.) along the balancing robot direction (W′), and (iii) turn the robot 102 to realign the fore direction to the robotic omniwheel 103 direction of travel.

In one embodiment the motion control system 132 comprising a method configured for controlling the yoke or “yaw” steering motor 113 of the robotic omniwheel 103, wherein the controlling of the rotation and lateral steering of the robotic omniwheel 103 is performed the yaw direction provided by the steering motor 113, and by using the attitude sensing system 135 characterized by following steps: a method configured for continuously measuring of the robot body 119 pitch .phi. and yaw .phi. .sub. .tau. angles using an attitude state sensor 136 situated on the robot's upper body is used to achieve level balance of the robot 102; a method pre-calculated by the computer operating system 131 configured for measuring the instantaneous angle .THETA. of the said robotic omniwheel 103 using an attitude state sensor 136 situated therein thus a fast control module 160 and a slow control module 161, the fast control module 160 comprises at least the following sensors: (1) an attitude state sensor 136 for robot balance continuously measuring and delivering the instantaneous pitch .phi. and roll .phi. .sub. .tau. angle values, referred to as the phi-angle sensor 162, and (2) a sensor for the relative angle THETA. between the body of the robot and the robotic omniwheel 103 direction, referred as a theta-angle sensor 163. In one embodiment the self-balancing robot system 100 comprising the theta-sensor 163 which is commonly implemented as an integral part of the robotic omniwheel drive motor 109; a method configured for providing a pitch angle .phi. .sub. .rho., a yaw angle .phi. .sub. .GAMMA., and angle .THETA. as inputs to a fast control module 164 which uses the pitch .phi. .sub. .rho. and the yaw angle .phi. .sub. .GAMMA. to determine a new direction W′ to which the robotic omniwheel 103 has to travel to restore level balance; a method configured for establishing by fast control module 164 a turning torque T.sub.WTL command to be applied to the robotic omniwheel's drive motor 109, or as a difference command to the segmented the steering motor 113, or both to turn to new direction W, and a command to be applied to the steering motor 113, or as a joint command to the segmented robotic omniwheel drive motor 109 to produce the amount of robotic omniwheel rotation S2 in this new direction W′, all in order to bring said pitch .phi. .sub. .rho. and said yaw .phi. angles to zero point by using the attitude sensing system 135, attitude state sensor 136 and the phi-angle sensor 162.

In one embodiment the motion control system 132 comprising a method pre-calculated by the computer operating system 131 configured for turning the robotic omniwheel 103 to the new robotic omniwheel direction W′ and rotating the robotic omniwheel by the amount of robotic omniwheel rotation .OMEGA.; a method configured for establishing by slow control module 161 a thrust torque T.sub.WTLt command to be applied to the robotic omniwheel drive motor 109 requiring trust to realign fore direction (U) to robotic omniwheel direction of travel (W).

In one embodiment the motion control system 132 comprising a method configured for turning the wheel to realign fore direction (U) to robotic omniwheel 103 direction of travel (W) and thus to restore .THETA.=0, where all steps are repeated; a method configured for stabilizing the robot 102 comprising steering motor 113 for controlling the steering of the robotic omniwheel 103 whereby a control algorithm 137 comprises at least three control loops: a fast rotation loop (FRL) 164, the fast turning loop (FTL) 165, and a slow loop 166 that performs fore direction correction (FDC) 167.

In one embodiment the motion control system 132 comprising a method pre-calculated process configured for the fast control loop 168 to measure the pitch .phi. .sub. .rho. and roll .sub. .GAMMA. angles (via the phi-angle sensor 162) and the instantaneous position of the omniwheel assembly relative to the robot body THETA. (via the theta-angle sensor 163), are fed as inputs to the fast control module 160. The target value for the angle Co is zero as the rider wishes to travel forward. Generally, in the normal operation, the pitch and roll angles will be non-zero and a correction of balance will be necessary. The fast control module 160 uses the pitch .phi. .sub. .rho. and roll .sub. .GAMMA. angles to determine the direction to which the robotic omniwheel has to travel to restore balance, i.e., to bring the pitch and roll angles to zero. The control algorithm 137 results in the new angle & between the robotic omniwheel direction W and the robot body direction U and the amount of robotic omniwheel 103 rotation .OMEGA. required to restore balance. The control algorithm 137 output is fed to the robotic omniwheel drive motor 109 to track the robotic omniwheel rotation. As soon as the new robotic omniwheel direction is established in the fast turning loop (FTL) 165, the robotic omniwheel travels an amount equal to .OMEGA. as provided by the common rotation of the drive motor 109 in the fast rotation loop (FRL) 164. The fast control loop (FCL) 168 cycle repeats.

In one embodiment inasmuch as the robotic omniwheel 103 traversing the robot 101/102 may not be perfect every time, due to varying terrains conditions and static friction slipping thresholds, the fore direction may have to be realigned with the robotic omniwheel direction. This is accomplished with the slow fore-direction correction loop (FDCL) 167 and the slow control module 141 that applies a restoring torque TFDC to the restore 0=0. The response time of the FDCL 167 is slower than the response times of both the wheel trust loop (WTL) 168 and the wheel rotation loop (WRL) 169 because more than one balancing turns may happen in a short time without the need to make fore direction correction. For this reason, the loop time constant of FDCI 167 control T.sub.S is much longer than the fast control loop 168 time constant T.sub.F A typical ratio is an order of magnitude. The fast control loop 168 time constant T.sub.F is determined by the required balancing time scale which depends on the moments of inertia of the self-balancing process 157 and is typical of the order of hundreds of milliseconds.

In further detail FIG. 9 the autonomous drive system 133 comprising a computing device 170, the computing device 170 comprising: one or more processors 147 for controlling the operations of the computing device 170; a wireless communications system 138 configured to communicate with network control system server 171 over a network system 151; and memory 148 for storing data information 150 and program instructions 149 used by the one or more processors 147, wherein the one or more processors 147 are configured to execute program instructions 149 stored in the memory 148, processor to send the data information 150 received from one or more sensors associated with the sensory system 154, and the motor controller processors 155 input and output devices 153 relay the data information to the processor via signal inputs 156.

In FIG. 9 the motion control system 132 methodologies include at least: 901. A computing device 170 comprising: one or more processors 147, gyro/MEMS, accelerometers 128 and the status sensors 131 for controlling the service robot 101 and the robot vehicle 102; 902. An I/O Interface 146 is configured to communicate with server 171 the network system 151; and memory 148 for storing program instruction 148 used by the one or more processors 147, LIDAR processor 176, the computer device processor 177 and the data information 150 received from the wireless communication system 138; 903. One or more processors are configured to execute instructions stored in the memory to: identify an unexpected driving environment; send information received from sensors; IMU 173, optical 174, location 175, and analog sensors 178 associated with the sensory system 154 and from the attitude sensing system 135; 904. The IMU 173 configured to capture changes in velocity, acceleration, wheel revolution speed, yaw, and distance to objects within the surrounding environment for use by the computing device 170 to estimate position and orientation of the autonomous robot 101 and the robot vehicle 102 steering angle, for example in a dead-reckoning system, not shown; 905. The sensory system 154 captures data representative of changes in x, y, and z-axis position, velocity, acceleration, rotation angle, and rotational angular rate for the service robot 101 and the robot vehicle 102; 906. A plethora of sensors capturing data for a dead-reckoning system, data relating to wheel revolution speeds, travel distance, steering angle, and steering angular rate of change can be captured; 907. The LIDAR sensors 134 capture intensity values and reflectivity of each point on the object to be used for analyzing and classifying the object, for example, one of the self-balancing applications 157 stored within or accessible to the self-balancing robot system's autonomous drive system's 133 computing device 170; 908. Optical sensors 158 capture images for processing by the computing device 170 used to detect traffic signals and traffic patterns, for example by capturing images of traffic lights, markings on the road, or traffic signs on common roadways and on smart highways 158, the smart highway system using proximity tags 159; 909. One or more GPS satellites 194 used to estimate the robot 101 and the robot vehicle 102 position and velocity using three-dimensional triangulation and time estimation, and point cloud of the LIDAR data captured by the location system 152, the LIDAR data information via the LIDAR processor 176 is stored in the memory 148; 910. One or more processors 714 are further configured to execute instructions stored in the memory 148 to send an autonomous command and to other robots and vehicles on the road may also be communicating with and sending data including sensor and/or image data to the network server 171.

In one embodiment the sensory system 154 utilizes a plurality of sensors disposed on the robot 101/102, for example, one or more sensors include an IMU sensor 173 can be configured to capture changes in velocity, acceleration, wheel revolution speed, yaw, and distance to objects within the surrounding environment for use by the computing device 170 to estimate position and orientation of the robot 101/102 and steering angle, for example in a dead-reckoning system. One or more sensors can also capture data representative of changes in x, y, and z-axis position, velocity, acceleration, rotation angle, and rotational angular rate for the vehicle and similar data for objects proximate to the navigation route of the robot 101/102. If the sensors capture data for a dead-reckoning system, data relating to wheel revolution speeds, travel distance, steering angle, and steering angular rate of change can be captured.

A sound sensor (not shown) is mounted on the robot body for detecting ambient sound signals the robot, the sound sensor and the is connected to the computer operating system which receives the sound sensor information feedback; the sound sensor is attached to a front portion of the robot body to measure distance detecting an obstacle in front of the robot to the robot from the sound sensor, the distance measuring sensor and the computer operating system 126 is connected, thus said the computer operating system 131 receiving the distance measuring sensor information feedback and the data is stored in memory 148.

As another example, LIDAR sensors 134 can capture data related to laser returns from physical objects in the area surrounding the robot with ranging distances calculated by measuring the time it takes for a signal to return to the LIDAR sensor 134 and a LIDAR processor 176.

The LIDAR sensor 134 is situated on the robot 101/102 however the height of the robot can maximize the degree of scanning area. Primarily the LIDAR geospatial positional data of the instantaneous robot/vehicle position is utilized by a processor 176 to calculate based on the distance of the object from the robot and its direction from the robot; the geospatial location of the objects in the field of view; the processor 176 and the autonomous drive system 133 can run on a Linux operating system, and the system algorithms can be programmed in Java programming language.

In various aspects using algorithms, users will be able to view the robot through the central PC monitor 141. The head systems image rendering device will determine by physical or nonphysical Computer-Generated-Imagery (CGI) feedback via a range finder scanning LIDAR processor system 176 disposed on the head 122 to scan a surrounding area of the robots physical environment; the local computer data signal 186 or positioning system is to identify the position of robot relative to said physical environment and to determine the orientation and motion of users relative to said environment. The LIDAR processor system 176 is communicatively coupled to the head system 200, said local positioning system, and said orientation and motion system, said processor configured to: generate a virtual map of said surrounding region based on data obtained from said scanning system; generate an augmented reality for said virtual map based on said user's position, orientation and motion within said physical environment based on data obtained from said local position system and said orientation and motion control system 132.

In one aspect the smart highway robot system 158 (detailed in FIG. 13) controls the operation of one or more service robots 101 and robot vehicles 102 respectively when driving on a smart highway or common roadway can utilize one or more sensors to detect traffic signals and traffic patterns, for example by capturing images of traffic lights, markings on the road, or traffic signs. For example, optical sensors 174 can capture images for processing by the computing device 170. As an example, by using the optical sensors 174 to read the lane markings on a road and can determine where the proper travel lanes are on that road (i.e., the space between two sets of lane markings). As another example, using text recognition processing, one or more optical sensors 174 can read traffic signs that state the legal speed limit on each road. This information can be used by the computing device 170 when operating the service robot 101 and the robot vehicle 102 in autonomous mode, as described below. In addition, the optical sensors 174 can be configured to capture single- or multi-spectral image data of the driving environment. One or more location sensors 175 can capture the position of the service robot 101 and the robot vehicle 102 in global networking systems; e.g., wireless control method is achieved through the autonomous drive system 133.

In one embodiment the autonomous drive system 133 is configured to process and calculate the functions of the autonomously controlled service robot 101 and robot vehicle 102, in this process the computing device 170 is operable electrically or otherwise is coupled with the autonomously drive system 133, the motion control system 132 and to mission-specific sensors within a common location determination architecture of the self-balancing robot system 100.

In further detail FIG. 10 the wireless communication system 138 is configured to be in communication with the self-balancing robot system 100 in real time, respectively to provide positioning information associated with a current location of robot 101 and of robot 102, respectively the Wireless Communication System 138 process methodologies comprising:

1001. The robot 101 robot and vehicle 102 IO Interface 146, locator device 152, wireless network 192, GPS satellite, Internet 195 and the operating system microprocessors 185, a bus interface 196 connect to an analog telemetry interface 176 and a digital telemetry interface 177 which connect to the network system 151.

1002. The analog telemetry interface, provides a connection 193 to a plurality of analog sensors and microprocessors configured to generate variable voltage signals to indicate their status, along with a RS232 interface 183 and radio/RF interface 182.

1003. The analog sensor is a thermometer which outputs temperature measurements as a voltage graduated analog signal.

1004. The analog telemetry interface 176 includes an analog-to-digital (A/D) converter 179 which converts received analog signals to their digital representations that can be further processed by microprocessors 185.

1005. The digital telemetry interface 177 provides a bidirectional connection to device 193 controlled by various digital input signals 180 and output signals 181 to and from interface bus 196.

1006. The radio interface 182 is further used to receive a remote computer data signal 187 from the network control system 151. The RS232 interface 183 provides a primary serial connection to RF interface 182.

1007. The digital output 181 is a relay which controls some operational aspects from location devices sensors 152.

1008. The bus interface 196 provides a bidirectional connection 189 to various computer systems, the data signals remotely 187 and locally 186 connecting to the satellite modem 191 and to GPS interface 184.

1009. The satellite modem 190 bidirectional connects 197 to the wireless network 192 via the RF interface 182, respectively for sending instructions respective to trajectory data 160-169.

1010. The wireless communication system 131 sending instructions respective to trajectory data to the bus interface 196 preferably by means of predetermined radio interface 182, and to wirelessly connect the Internet 195 the process is configured by the computer operating system 131.

Primarily the computing device processor 177 is configured to execute instructions stored in the memory 148 based on a quality metric of a network interface system 151 wherein, the information sent over a network control system server 171 is based at least in part on a quality metric of the network system 151. The network system 151 including one or more processors 150 are further configured to execute instructions stored in the memory 148 to send an autonomous command to one or more autonomous robot systems 100 based on a quality metric of the network system 151 and by the wireless communication system 138.

In one aspect the computer operating system 131 has redundant I/O interface manager 146 for managing communications between an incorporating computer operating system 131 and an external system such as a network system 151 or multi-port disk array, not shown. A redundant I/O interface manager 146 directs communication through one of the redundant I/O interface modules not shown, switches the communications through the other, e.g., when a failure of the first I/O interface module is detected or predicted. The redundant I/O interface module appears to the computer operating system 131 of the incorporating system as the first I/O interface module would so the switching is effectively invisible to the computer operating system 131 via the network system 151 see FIG. 11 herein.

In further detail FIG. 11 shows a prospective block diagram of the wireless communication system 138 configured to utilize the I/O interface manager 146 incorporating the network system 151, the block diagram showing system processes comprising herein: the network server 171, a location device sensors 175, a plurality signals from GPS satellites 194, the Internet 195, and computer subsystems including; computer device 170, processors 147, a bus interface 196 which is connect to an analog telemetry interface 176 and a digital telemetry interface 159 which connect to the network system 151. The analog telemetry interface 1176 provides a connection to a plurality of analog sensors 178 configured to generate variable voltage signals via local computer data signals 186 to indicate their status, along with a radio/RF interface 182 and the RS232 interface 183.

In one or more embodiments the I/O Interface system utilizes the analog telemetry interface 176 sensor as a thermometer which outputs temperature measurements as a voltage graduated analog signal, and the system utilizes GPS interface 184, and also the I/O Interface system utilizes a plurality of microprocessors 185. The analog telemetry interface sensors include an analog-to-digital (A/D) converter 179 which converts received analog signals to their digital representations that can be further processed by microprocessors 185. The digital telemetry interface 177 provides a bidirectional connection to said devices controlled by various digital input signals 180 and digital output signals 181, also, to and from bus interface 196. The radio interface 182 is further used to receive a remote computer data signal 187 from the network system 151. The RS232 interface 183 provides a primary serial connection to RF interface 181. The digital output signals 181 is a relay which controls some operational aspects from location devices 175 having one or more sensors, not show. The robot bus interface 196 provides a bidirectional connection 197 to computer systems data signals remotely 187 and locally 1186 thus connecting to the satellite modem 191. The satellite modem 191 bidirectional connects 197 to the network system 151 via the RF interface 182, respectively for sending instructions respective to trajectory data 160-169. The wireless system respectively for sending instructions respective to trajectory data 160-169 to the autonomous drive system 133, and preferably via a predetermined radio interface 182 wirelessly connects the Internet 195. In one aspect the process is configured to and from the wireless network system 151 computing device 170 communicating to and from the computer operating system 131.

In various aspects the computing device 170 comprising: one or more processors 147 for controlling the operations of the computing device 170, and the communications I/O Interface system 146 is configured to communicate with a server 171 via the network system 151; and utilizes memory 148 for storing data information 150 from program instructions used by the one or more processors 147; one or more processors 147 are configured to execute programmed instructions stored in the memory 148 to: identify an unexpected driving environment; send information received from one or more sensors associated with the sensory system 154.

In various aspects the location device 175 is a wireless communication device commonly installed in robots to provide location-based communication services such as, for example, asset tracking and reporting. The Internet 195 which is utilized for access communications, and telemetry monitoring or control. The bus interface 196 enables communications between the location device 175 and other devices herein, integrated or external the methods include at least: a bus interface 196 which includes the analog telemetry 176 interface to provide a connection 193 from a plurality of analog sensors 178 to generate variable voltage signals to indicate their status. A common example of an analog sensor is a thermometer. The analog telemetry interface further includes an analog-to-digital (A/D) converter not shown, which converts received analog signals to their digital representations can be further processed by microprocessors 185. The RS232 interface 183 provides a primary serial connection not shown. The wireless communication system 138 respectively for sending instructions respective to trajectory data 160-169 to the motion control system 132 preferably via a predetermined radio frequency 182.

A common example of a device connected to the digital output 181 is a relay which controls some operational aspect of the robot system 100 in which it is installed, for example; a compartment roll top door-mounted motor which generates a logic HIGH signal when a compartment door opens un-expectantly, this process is not shown, or other example when recharging the batteries 140, the robot system is receiving a logic HIGH signal from the digital telemetry interface 177 alerting the battery is charged, this process is not shown.

The robot system 100 bus interface 196 provides a bidirectional connection to various drivers, the bus drivers include a wireless driver not shown, which enables communications to/from the wireless network 151.

In further detail FIG. 12 illustrates a block diagram of the articulated head system 200 configured with various systems, processes, and contrivances which include at least: a logic controller 201, an external data source 202, a heads up display 203, an image rendering module 204, a LED system 205, a LED display monitor 206, an expression output module 207, a LED eye formation 208, a LED lip formation 209, a vocal system 210, and a language system 211. As illustrated the head system 200 comprised within the robot head 122 section, accordingly the head 122 is comprising a method to be attached by the neck 123 by means of coupling 127(N) which is fabricated during the manufacturing process. The head system 200 is configured to interact with users by verbally communicating whereby the head system 200 is primarily a subsystem controlled by the computer operating system 131 utilizing an optical sensor 171, and other devices described herein.

As shown in FIG. 12, the head system comprising a LED system for displaying special effects inside the head 122 on a LED display monitor, thereby the user can view the images on the outside of the head, the head further comprising: a transparent plastic form having the shape of a human face the form comprising an upper section and a lower section respectively to house the following head system components. The LED display monitor 26 is configured for displaying images with life like interactive facial expressions via a computer generated process having different scenarios via preprogrammed instructions. The flexible micro LED grid not shown is affixed to the inner contours of the head 122, respectively the flexible micro LED grid is fabricated with an opaque silicon component this process is produced by the manufacture. The LED grid comprising wiring connections and USB cable for connecting the micro LED grid to the LED display system, and also the internal computerized LED display system is to include pre-programmed special effects software, and also to include a library of computer generated faces configured with different eyes, eye brows, noses, lips and ears, the nose and ears.

The logic controller 201 configured to receive video signals from external data sources 202 via devices. Examples of external data sources 202 include one or more video cameras 198 that are disposed external to the service robot 101 body and the robot vehicle 102 cargo container 143. In various aspects the video camera 198 signals are then provided to image rendering logic 204 of said logic controller 201. The logic controller 201 includes a heads up display 203 generation logic data, in some embodiment's data information from one or more external data sources 202 that are external to the robot system 100, the robot system 100 is received and transformed into a heads up display 203 comprised of generated logic data.

In one embodiment the heads up display 203 generation logic data can be visually displayed on the heads LED display via the LED system 205 for user interfacing. The heads up display, in some embodiments, provides a dashboard-style representation to represent such information. The heads up display produced by the heads up display generation logic is also provided to the image rendering logic 204.

The logic of the controller 203 also to receive signals from image rendering logic 204 to determine a portion of the video signals from the video cameras 198 that will be rendered as an image to the display generation logic.

In order to generate the user view of data information the robot's space is defined as having a frame of reference fixed to the robot, such as to a location in the head 122 of the robot. The logic is configured with for each video camera 198 such as the spatial coordinates that define the camera's position and aim in real space relative to the frame of reference fixed to the robot. Such information can also comprise the properties of the camera's lens (e.g., wide or narrow angle) that together with the spatial coordinates defines a field of view of the video camera 198 in real space, such as the fields of view, and similarly defines the corresponding view for the video camera 198 relative to the same frame of reference within the robot space.

As different scenarios are utilized by the robot system 100 the methodologies of the head system may comprise the following embodiments and their functions; a field of view of a video camera 198 which is a representation of that portion of the robot's visual environment that is received by at least one video camera 198. As used herein, a view in a virtual space, such as the robot space, is a representation of a hypothetical projection of the video signal from a point in the virtual space onto a screen at some distance from that point. Since the logic is configured with the information noted above, the logic is able to construct views in the robot space that have the same spatial relationships as the fields of view of the video cameras. Accordingly, where fields of view such as overlap in real space, the corresponding views of the video cameras in the robot space also overlap.

In one embodiment the articulated head system 200 including an input device or the image recognition as a general camera and the video camera 198 are placed accordingly on the robot and installed as an input device or as a general a video camera 198, or secondary camera for video use for the image recognition, the cameras are connected to the robots computer operating system 131 wherein: the computer operating system 131 via wireless network 192 is connected to a third-party software share data API interface or other software developers.

In one embodiment the articulated head system 200 is including a vocal system 210 and a language system 211 an expression output 207 of life like actions of emotion whereby to be expressed by the LED eyes 208 and by the LED lips 209, respectively this action is achieved by means of a LED system 205 and a LED display system 206.

The robot body compartment 130 is configured for playing music, the compartment 130 is comprising one or more speakers 199 not shown, and the LED system 205 is situated inside the heads lower section, wherein LEDs lights (not shown) are connected to the computer operating system 131. The mounted speakers 199 and LED lights (not shown) are synchronized to the expression output 207 of the LED display system 206 to coincide with the vocal system 210 and language system 210 and the eyes 208 and the LED lips 200 the audio speaker 199 for the voice is situated with the PC monitor's 141 devices.

In one aspects the articulated head system 200 is including a vocal system 210 and a language system 211 an expression output 207 of life like facial movement.

In one embodiment modular LED light units (not shown) of the LED system 205 are utilized for displaying special effects via a LED grid system for displayed computer generated images on a computerized visual face monitor, not shown.

In one aspect the articulated head system 200 is configured with a transparent plastic having the shape of a human face, and furthermore, the head 122 sections are comprising wherein; the computerized visual face monitor exposed to optically project special effects inside the head, and to then be seen from outside, respectively the face monitor screen is displaying images in real time via video cameras, or displaying simulated images in virtual time via a computer generated process, different scenarios apply.

In one or more aspects the articulated head system 200 is comprising wherein the computerized visual face monitor with life like interactive facial expressions wherein, a computerized optical projection system using an internal computerized LED display system 206 works accordingly to display computer generated facial expression via the facial expression output system 207 which includes pre-programmed special effects software including a library of computer generated faces configured with different eyes, eye brows, noses, lips and ears, the nose and ears are not shown in the drawings.

In one or more aspects the articulated head system 200 is comprising wherein; a computer generated process the LED display system 206 is capable of displaying patterns of various colors including; red, yellow, blue, green, and so forth, which are projected through the upper and lower transparent plastic sections of the head 122. The LED display system 211 further comprises a micro LED grid situated on an opaque layer of flexible heat resistant silicon (not shown). In one embodiment the flexible micro LED grid is affixed to the inner contours of the head 122, respectively the flexible micro LED grid in barely visible because of the opaque silicon component, the grid is wired via wiring connections 116 and the USB 115 is connecting the micro LED grid to the LED display system 206 e.g., this device and assembly process is fabricated by the manufacturer.

In one embodiment the LED display system 206 is capable of depicting variety of faces at least that of female facial features (e.g., shown in the drawings of FIG. 1, FIG. 2, FIG. 4, FIG. 5 and FIG. 12) and also the robot can have male facial features, not shown. Accordingly in various aspects the female face or male face can be detailed glimmering make up and the have the appearance of wearing lip stick, and also the head is having virtual ears shapes, the ears include life like earrings via a computer generated process, not shown, and as well the LED display system 206 is capable of depicting various lengths of hair actively flowing in life like motion, the hair may change colors via a computer generated process, different scenarios apply, not shown.

One or more methods of the head system 200 including the head 122 is to comprise a LED facial display system 206 which may utilize input and output devices such as; WIFI, Bluetooth, various satellite and telecommunication elements including; at least one computing platform associated with one of a smartphone, a computer, or an interactive information devices such as “Alexia™” or “SIRI™” or other built-in “intelligent assistants”, and also one or more network interface servers and buses, and so forth, (e.g., the robot input and output communication devices and intelligent assistants are not shown).

In one or more aspects the articulated head system 200 is comprising wherein one or more internal communication systems communicatively coupled to a peer robot via wireless communication, wherein processors accordingly via an identifier system recognize a fellow robot peer and convey information related to a configuration of other peer robots via a computer generated process and relay the data information 150 to the user's PC monitor 141, this process is not shown.

In further detail FIG. 13 the smart highway positioning system 158 configured with a wireless communication system 138 configured to be in communication with the self-balancing robot system 100 in real time, respectively to provide positioning information associated with a current location of robot 101 and of robot 102 traveling on the smart highway system 158. The smart highway system 158, for example gathers the robot vehicle 102 position information by proximity tags 161, and respectively the smart highway positioning system not shown, comprising the positioning information relayed from a plurality of real time-dependent smart highway proximity tags 161, proximity tags 161 are sensors that would preferably be embedded in or alongside the road surface (e.g., on either opposing sides as shown) in or alongside the lanes.

In several aspect the proximity tags 161 obtain data about the road surface and also obtain data information about the robots 101/102 as the data is being directed to transmitters for transmission to the smart highway control network (e.g., upon the smart highway control network when it is established this processor is achievable). The data information 150 pertains to transmitting information to robots 101/102 from infrastructure-based transmitters, and each proximity tag 161 being dependent on a data structure is comprising spatial coordinates locatable relative to the GPS map and tag data information relayed from robots 101/102, wherein the spatial coordinates are associated with the robots 101/102 autonomous drive system 133 I.D. code is recognized by a smart highway control network (once established). This process is configured for smart highway registration tags would scan the robots 101/102 identification code like a license plate number only digital, this process determines the owner of the robot and aforesaid processes are not shown. The robot system 100 service robots 101 and robot vehicles 102 will be required to have an I.D. respectively the coding system will be handled by an agency like the “Department of Motor Vehicles”, accordingly when established the robot 101/102 registration fee is surely a requirement (e.g., as the recent drones regulations are now established as of 2016).

In one aspect when a significant number of vehicles have the capability of operating in a fully-autonomous manner, then dedicated smart highway lanes for just service robots 101 and robot vehicles 102 and also for autonomous passenger vehicles which are all operating on the smart highway lanes and can all travel in close-packed in high speed cavalcades (e.g., as shown 101(A)a-101(A)c). Accidents in these lanes will not occur and the maximum utilization of the smart roadway and smart highway infrastructure is certainly a safer system than present day roadway infrastructure.

In one aspect the smart robot vehicle 102 whilst driving on smart roadways and smart highways can utilize the Internet 195 and wireless communication system 138 methodologies for conveying information to and from a plethora of service robot and service vehicles traveling on the same pathway. Methods can include a first robot vehicle 102(A) to a second robot vehicle 102(B) through a fixed structure as the first and second robot vehicles travel along smart roads, comprising a method for: generating information about external conditions around the first robot vehicle 102(A) using a robot/vehicle-based data generating system not shown; and using at least one of a plurality of transceivers that use a long range system to wirelessly communicate with the first and second robot vehicles as the first and second robot vehicles travel along the smart roads/highways and that provide a ubiquitous Internet along a network of roads along which the first and second robot vehicles may travel and a first communications system on the first robot vehicle 102(A) to transmit the generated information about conditions around the first robot vehicle 102(A) a from the first robot vehicle 102(A) to a second communications system on the second robot vehicle 102(B) and then to a third robot vehicle 102(C), and so forth, via at least one of the transceivers using the smart roads/highways system 158 method and the robot systems 131-133 and the Internet 195 and wireless communication system 138.

In another aspect the smart robot vehicle 102 whilst driving on roadways and smart highways can utilize s wireless communication method for conveying information from a first service robot 101(A) to a second service robot 101(B) through a fixed structure as the first and second service robots travel along a road, comprising a method for: generating information about external conditions around the first service robot 101(A) using a robot/vehicle-based data generating system not shown; and using at least one of a plurality of transceivers that use a long range system to wirelessly communicate with the first and second service robot as the first service robot 102(A) and second service robot 102(B) and a third service robot 102(C) travel along the smart road/highway in a cavalcade and that provide a ubiquitous Internet 195 along a network of smart roads/highways along which the first and second robot vehicles may travel and a first communications system on the first service robot 101(A) to transmit the generated information about conditions around the first service robot 101(A) from the first service robot 101(A) to a second communications system on the second service robot 101(B), to transmit the generated information about conditions around the first service robot 101(A) to a second service robot 101(B) and then to a third service robot 101(C), and so forth, via at least one of the transceivers using the smart highway system 158 method and the robot systems 131-133 and the Internet 195 and wireless communication system 138 as described herein.

Respectively to prevent the robot obstacle collision avoidance, the autonomous drive system 133 utilizes an array of sensors for obstacle avoidance the sensor include at least that of IMU sensor 173, LIDAR 134, optical sensor 174, location sensor 175, and positioning system tag sensors 161. The autonomous drive system 129 computing device 170 is connected to the obstacle avoidance sensors to receive data information feedback via processors 147, communication interface 151, and the data is stored in memory 148.

It will be understood that the arrangement of components may vary. The wireless communication system 138 is detailing the process configured for a plurality of communication devices operable to wirelessly communicating with one or more robot and autonomous vehicles which work in conjunction with a global positioning system or GPS satellite location system 188 to determine a course for the robot system 100 to reach an objective while detecting and avoiding obstacles along the course. Wherein said communication devices wirelessly communicate with a remote server of said communication system; and wherein said remote server 171 receives map data information from GPS satellite 194 pertaining to one or more robots and, responsive at least in part to the received data information 150, receptively the remote server communicates information to of one or more robots via wireless communication devices such as; the Internet 195 and input/output devices 153 such as; video cameras 198, and also WIFI, Bluetooth, which are not shown.

The self-balancing system 100 comprising process methods configured to determine, based on the received sensor data, at least one object of the environment that has a detection confidence below a threshold, wherein the detection confidence is indicative of a likelihood that the determined object is correctly identified in the environment; and based on the at least one object having a detection confidence below the threshold: communicate, from the received data, image data of the at least one object for further processing to determine information associated with the at least one object having a detection confidence below the threshold and process received information data from the autonomous control sensory system 154 providing the object indication data. For example, the sensory system 154 may include infrared sensors, RADAR sensors, ultrasonic sensors, infrared sensors, and so forth, any of which may be used alone or in combination with other control system processors and sensors described herein to augment autonomous robot 101 and robot vehicle 102 navigation.

In one embodiment, the steering system for the robot vehicle 102 utilizing two robotic omniwheels may include an electrically-actuated rack-and-pinion steering system coupled to a plurality of the robotic omniwheels to control the orientation of the one of the robotic omniwheels and thus control the direction of travel of the robot vehicle as shown in FIG. 13.

In one embodiment a robot cargo vehicle 102(C) comprising four wheel drive is capable of supporting the weight of the vehicle and the cargo, the steering motor 113 steers the robot cargo vehicle 102(C), as shown.

In other embodiment the cargo vehicle is powered by a propulsion system which can include an array of common trucking wheels controlled by a steering system in perspective a rack and pinion steering method, this method is not shown.

In yet other embodiment the robot cargo vehicle is powered by a propulsion system which can include using a set of motorized wheels comprising an electric hub motor however, the wheels are attached to opposing front and rear axles 110, this method is not shown.

With regard to the processes, systems, methods, heuristics, etc. described in the above mentioned, it should be understood that, although the steps of such processes, etc. have been described as occurring according to a certain ordered sequence, such processes could be practiced with the described steps performed in an order other than the order described herein.

The robot 101 and may include an array of one or more frame and body types, modular attachable and detachable contrivances in any order; an articulated head, a neck, shoulders, arms, legs, a hand, a foot, and other appendages capable of gripping objects, and as well the robots 101 and robot vehicles 102 further comprising: one or more of the following mobile platforms: a uni-wheeled mobile platform, a bi-wheeled mobile platform, a tri-wheeled mobile platform, a quadrat-wheeled mobile platform, a fifth-wheeled mobile platform, and so forth.

An array of sensors configured to detect events or changes in an environment and to report status of the process functioning the variety of sensors include accelerometer sensors, and various tactile sensors placed on the frame, body, and sensors within various contrivances.

The PC monitor 141, the monitor to set on the robot body 119 such as set on the torso, the PC monitor 141 comprised one or more compositions to optically project LED and pixel imagery via a computer generated process, and a method of one or more special effects composition or other means forming the constituent to optically project LED and pixel imagery.

At least one power generation comprising control subsystems for external and internal environment usage including; a rectenna power system for continuous power supply when mobile, and piezoelectric power generation, a wireless charging station, port, or dock, and other power supplying methods when idle.

It further should be understood that certain steps could be performed simultaneously, that other steps could be added, or that certain steps described herein could be omitted. In other words, the descriptions of processes herein are provided for the purpose of illustrating certain embodiments of the diagrams and flowchart scheme, and should in no way be construed so as to limit the claims.

Accordingly, it is to be understood that the above description is intended to be illustrative and not restrictive. Many embodiments and applications other than the examples provided would be apparent upon reading the above description. The scope should be determined as set forth above and may encompass multiple distinct inventions with independent utility. Although each of these inventions has been disclosed in its preferred form(s), the specific embodiments thereof as disclosed and illustrated herein are not to be considered in a limiting sense, because numerous variations are possible.

The subject matter of the inventions includes all novel and nonobvious combinations and sub combinations of the various elements, features, functions, and/or properties disclosed herein. The following claims particularly point out certain combinations and sub combinations regarded as novel and nonobvious and respectively features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

I claim:

1. A humanoid robot comprising:
a humanoid robot comprising artificial intelligence configured for completing complex human like physical actions based on AI algorithms and/or user interface instruction;
a head and body rotatably linked together by an actuating collar and a fulcrum torso module arrangement, the actuating collar rotatably coupled to robotic arms, an actuating spine configured for linking the fulcrum torso module with actuating pelvis, and an actuating hip rotatably coupled to robotic legs;
wherein the actuating collar, fulcrum torso module, actuating spine, and actuating pelvis providing multiple degrees of freedom for accomplishing physical stunts;
wherein the robotic arms are connecting to manipulator implements configured for handling objects, the robotic arms providing multiple degrees of freedom for accomplishing physical stunts;
wherein the robotic legs are connecting to a foot or to a wheel, the robotic legs are configured for providing multiple degrees of freedom for accomplishing physical stunts;
wherein the wheel including a motor connected therein, wherein the motor to provide fore or aft propulsion with braking capability;
batteries for providing power, a battery charging system, and a charging module situating on the body;
wherein the head and body further comprising proximity sensors and cameras configured for detecting objects surrounding the humanoid robot, wherein the sensors and cameras generating object data, image data and modulated signals;
a control system associating with user interface, a wireless communication system, and GPS;
wherein user interface providing instruction through wireless communication such that, the humanoid robot operates autonomously to complete tasks;
wherein the wireless communication system involving one of; I/O devices, smart external devices utilizing Wi-Fi, Bluetooth, APPS, cloud computing through the Internet of Things (IoT);
wherein GPS provided for generating route data and positioning data allowing the humanoid to travel to locations;
wherein the control system providing AI decision-making algorithms for generation path planning based on, object data, image data, and GPS data;
an autonomous mode or a semiautonomous mode for the controlling of operating modes involving one of; a walking mode, a driving mode, a dancing mode, a leaping mode, a battery charging mode, or other maneuvering modes;
AI decision-making algorithms for controlling rotational speed and maneuver position of one or more joint mechanisms, servos, actuators, and manipulators to accomplish maneuvering actions.

2. The humanoid robot of claim 1, wherein the body further comprising:
batteries for providing power, a battery charging system, and a charging module situating on the body configured to receive an external charge port charging process through AI algorithms instruction or user interface instruction;
a control system configured for autonomously dock the humanoid robot on an external battery charging station, the control system configured for controlling a charging procedure of the humanoid robot when docked an external battery charging station;
a wiring array linking the control system& to electrical connections throughout various parts of the body, wherein the wiring array preferably is hidden from view.

3. The humanoid robot of claim 1, wherein the body's actuating collar, fulcrum torso module, actuating spine, actuating pelvis, robotic arms, and robotic legs configurations further comprising actuators being at least power driven by at least one of; electricity, pneumatics, hydraulics, or other motorized process.

4. The humanoid robot of claim 1, wherein the head further comprising:
a head being integrated helmet, a front section of the head encompassing a display monitor, accordingly the display monitor is removably connected on the helmet, the display monitor linked to a microphone, speakers, cameras or other sensors; or
a head having a preferred shape with a durable thickness forming a cavity containing a compartment with an access cover, a display monitor linking to a control system, when linked, the display monitor begins displaying virtual images or special effects of various facial images; or
the head constructed with eyes, a nose and an articulated mouth covered with a supple outer layer of skin exposing actuating eyes and an articulated moving mouth.

5. The humanoid robot of claim 1, wherein the robotic arms further comprising:
a right robotic arm and a left robotic arm each having a first end, a second end, and an end effector;
the first end being connected to a shoulder joint actuator and connected to an elbow joint actuator providing a connection of the second end;
the second end connected to a wrist joint actuator rotatably coupled to an end effector;
the end effector configured to attached or detach a manipulator;
a wiring means routed entirely inside the first end, second end and an end effector such that the wiring is not visible;
a robotic hand, gripper, a working tool, or a wheel, or other implements having a movable portion to stabilize a pose position of the humanoid robot.

6. The humanoid robot of claim 1, wherein the robotic legs further comprising:
a right robotic leg and a left robotic leg each having an end effector;
a first end being connected to a hip joint actuator and connected to a knee joint actuator providing a connection of the second end;
a second end connected to an ankle joint actuator rotatably coupled to an end effector;
the end effector configured to attached or detach a manipulator;
a wiring means routed entirely inside the end effector such that the wiring is not visible;
a foot configured for gripping to a surface; or
a wheel including a motor being an electric motor, or a servo motor, or a motor having a gear arrangement, the motor to accomplish fore and aft velocity and a braking arrangement, wherein the wheel connects to the end effector.

7. The humanoid robot of claim 1, wherein the body further comprising:
an actuating collar, a fulcrum torso module, a spine , and actuating hip configurations allow the humanoid robot bend at various angles or to balance, the motion and position of the humanoid robot being generated by one or more of;
a plurality of accelerometers, motion sensors, and gyro sensors configured to identify or localize motion parameters and provide dynamics data including roll, pitch, yaw angles, attitude and velocity of the body and stabilization of parameters including at least one of counteracting angles of the one or more joint mechanisms, servos, actuators, and manipulators.

8. The humanoid robot of claim 1, wherein the body further comprising:
a plurality of cameras, wherein the plurality of cameras configured for real-time object detection, to capture surrounding imaging or to provide live video of an object in an operating environment;
a plurality of proximity sensors, LIDAR, Radar and other sensors for collision avoidance, to detect a user, to localize objects in an operating environment, a plurality of touch sensors responsive to a touch sensor input.

9. The humanoid robot of claim 1, wherein the control system further comprising:
AI decision-making algorithms associated with one or more accelerometers or IMUs providing X, Y and Z axis of rotation to alter the height and pitch angles of shoulders, robotic arms, waist, pelvis and robotic legs such that the present humanoid robot's body moves liken to how humans move;
AI decision making algorithms configured for the controlling of force, rotational speed, trajectory of the one or more manipulators;
AI decision-making algorithms associated with motor controllers configured for controlling the motion of the one or more power-driven manipulators of the humanoid robot to accomplish maneuvering actions.

10. The humanoid robot of claim 1, wherein the control systems further comprising:
AI decision making algorithms associating with instructions for generating rotational speed of a wheel;
AI decision making algorithms associating with instructions to accomplish maneuvering actions of steering control, or propulsion control of the wheel.

11. A humanoid robot comprising:
a humanoid robot comprising artificial intelligence configured for completing complex human like physical actions based on AI algorithms and/or user interface instruction;
a head rotatably connected to an actuating collar via a neck joint, the head and a body rotatably linked together by the actuating collar and a fulcrum torso module arrangement, the actuating collar rotatably is coupled to robotic arms, an actuating spine and an actuating waist module configured for linking the fulcrum torso module with actuating pelvis, and an actuating hip rotatably coupled to robotic legs;
wherein the actuating collar, fulcrum torso module, the actuating spin the and actuating pelvis providing multiple degrees of freedom for accomplishing motion or physical stunts;
the actuating collar, fulcrum torso module, actuating spine, actuating pelvis, robotic arms, and robotic legs configurations further comprising actuators being at least power driven by one of; electricity, pneumatics, hydraulics, or other motorized process;
wherein the head and body comprising an exoskeleton structure including front, back and side segments constructed with a convex shell having a preferred shape and thickness and a fastening means for connecting onto the arrangement of brackets;
wherein the actuating spine to heterogeneous bend forwardly at or to bend backwardly at or providing other multi-axis degree movement;
wherein the actuating waist module configured with flexing segments capable to bend along with the upper portion respectively forwardly, backwardly, flexing segments can flex side to side and twist such that, the humanoid robot can actively perform stunts;
a control panel housed within a portion of the body, wherein the control panel linked to the control system, wherein the control panel comprising touch display for displaying an articulated hierarchical menu listing a control system having touch display for displaying an articulated hierarchical menu listing a variety of task functions, user interface, face recognition, speech recognition, autonomous interface for selecting operating modes to accomplish various motions to maneuvering actions via the control system associated with autonomous interface to accomplish various social interactions and task handling jobs;
wherein the head and body comprising proximity sensors and cameras configured for detecting objects surrounding the humanoid robot; wherein the proximity sensors, LIDAR, Radar and other sensors for collision avoidance, to detect a user, or localize objects in an operating environment; wherein the cameras configured for real-time object detection, to capture surrounding imaging or to provide live video of an object in an operating environment;
AI decision-making algorithms for controlling rotational speed and maneuver position of one or more joint mechanisms, servos, actuators, and manipulators to accomplish maneuvering actions;
AI decision-making algorithms for generation path planning based on sensors, cameras, and GPS generating route and positioning data for traveling;
an autonomous mode or a semiautonomous mode for the controlling of operating modes involving one of; a walking mode, a driving mode, a leaping mode, a dancing mode, a battery charging mode or other maneuvering modes;
AI decision-making algorithms associated with an autonomous mode or semiautonomous modes for the controlling maneuvering actions such that humanoid robot physically moves similar to how a human physically moves to accomplish the actions involving; manipulating objects, stair stepping, walking, running, dancing, leaping, climbing or other physical actions;
user interface providing instruction through wireless communication such that, the humanoid robot operates autonomously to complete tasks;
a wireless communication system involving one of; I/O devices, smart external devices utilizing Wi-Fi, Bluetooth, APPS, cloud computing through the Internet of Things (IoT) and cloud management;
batteries for providing power, a battery charging system, and a charging module situating on the body configured to receive an external charge port charging process through AI algorithms instruction or user interface instruction;
one or more LED lighting units which may include head lights, tail, brake lights and turn signals;
a wiring array and electrical connections linking through the bracket lengths and through the exoskeleton structures such that the wiring array is hidden from view;
a wiring array and electrical connections linking regulated battery power to the aforementioned components.

12. The humanoid robot of claim 11, wherein the user interface further comprising:
a control panel having a graphical user interface with touch display displaying at least one of a function or mode of operation of the humanoid robot, representing virtual control element on the touch display, selecting a desired function or operating mode by operating the at least one virtual operating element by an authorized user, detecting the confirmation of the at least one virtual operating element and sending a control signal corresponding to the selected function or operating mode to the control system;
wherein the user interface further comprising operation interface management linking to various external I/O computing devices associated with smartphones or smart wearable devices;
wherein the control panel including at least one microphone for user interface communication, at least one speaker associated with user interface communication, wherein the at least one microphone and the at least one speaker linked to the control system.

13. The humanoid robot of claim 11, wherein the user interface further comprising:
a head including at least one compartment for housing a display monitor, wherein the display provides a touch screen for user access, a virtual display function, a virtual control element for selecting a desired task operating mode respective of a voice recognition process, or
a face recognition process linking a user, or a virtual control element for selecting a task operating mode respective of a voice recognition process linking to a control system, and/or a virtual control element for selecting a task operating mode respective of a face recognition process linking to a control system, and a wireless communication system;
the wireless communication system linking smartphones, smart devices, wearable accessories or Virtual Reality devices with the user such that, the user can access the control system by virtual means to communicate with the humanoid robot;
the smartphone or smart device configured to receive data from sensors or cameras, the data corresponding to an environment about a humanoid robot, and receive an input of a location within physical space of the environment about the humanoid robot, determining, by the AI decision-making algorithms, a direction of travel for navigating the humanoid robot in the environment.

14. The humanoid robot of claim 11, wherein the control system further comprising:
AI decision-making algorithms, software programming providing methodology for controlling the motion of a humanoid robot such that the humanoid robot can physically move similar to how a human physically moves to reposition pose maneuvers, perform stunts, or entertain users, or to mimic physical attributes of a user when tasking;
wherein the humanoid robot, via AI decision-making algorithms, is configured for managing handling operations and/or driving operations in operating environments such as game play environments, working at home and commercial work involving; fulfillment warehouse picking, manufacturing, delivery, shopping, retail sales, medical, safety, recovery, military, exploration, agriculture, food service involving food preparation, cooking, packaging, cleaning, and other occupations;
wherein the humanoid robot, via AI decision-making algorithms, is configured for performing a series of maneuvers for climbing, stair stepping and reaching, respectively during stepping, running, skating, leaping, jumping, both robotic arms and robotic legs forcefully extend relative to a preferred pitch axis for repositioning a pose balance of the body, accordingly in some implementations the robotic arm may be oriented at an oblique angle relative to facilitate dexterity and relative to balance control of the body, both robotic arms forcefully extend relative to a preferred pitch axis for repositioning a pose of the body, both robotic arms forcefully swing or reach in any direction to counter-balance the body.

15. The humanoid robot of claim 11, wherein an interactive user interface methodology comprising:
a plurality of input devices, for use in accepting data defining a physical space domain of the humanoid, or a physical space domain including a physical space occupied by a user;
an input manager for use in obtaining the data from input devices, calibrating movements detected in the physical space domain to corresponding coordinates in the physical space of a user, and converting the data into an input frame representing a coherent understanding of the physical space domain and the action of the humanoid robot within the physical space domain;
an action scheduler controls said humanoid robot according to real time responses to accomplish complex actions within the physical space domain in a manner that may interact with the user;
wherein said response generation module initiates parallel operations of at least one of response by said humanoid robot to interact;
wherein the initiated parallel operations can include said humanoid robot to perform actions in real as requested via user inputs, wherein the user inputs include at least one orientation of body motion or orientation of position.

16. The humanoid robot of claim 11, wherein the user interface to communicate with the humanoid robot the method comprising:
a multi-modal input, for use in accepting data defining a physical space domain distinct from an operating environment;
a knowledge base, for use in mapping physical space domain data, and actions by the user within the physical space domain, to an interaction with the operating environment;
a response processor for scheduling an appropriate system response based on an understanding of the physical space domain and actions of the user.

17. The humanoid robot of claim 11, wherein the user interface further comprising:
an action scheduler that controls the humanoid robot according to real time responses and/or complex actions in a manner which interacts with a user;
a multi-modal understanding component configured to generate an understanding of speech and associated non-verbal of user inputs;
a response planning component configured to plan a sequence of communicative actions based on understanding instructions;
a multi-modal language generation component configured to generate sentences and associated gestures applicable to a sequence of communicative actions;
a multi-modal input, for use in accepting data defining a physical space domain distinct from an operating environment;
a knowledge base, for use in mapping physical space domain data, and actions by the user within the physical space domain, to an interaction with the operating environment;
a response processor for scheduling an appropriate system response based on an understanding of the physical space domain and actions of the user.

18. The humanoid robot of claim 11, wherein the AI decision-making algorithms for the humanoid robot operates autonomously to complete tasks involving one or more of:
determining a humanoid robot interface response for defining a physical space domain distinct from an operating environment of a detected user or an operating environment of a detected object;
detecting a physical space domain occupied by a user; or detecting a physical space domain of an object;
mapping a physical space within the operating environment of the detected user, or mapping a physical space within the operating environment of the detected target object;
interpreting input data of physical space information data associated with the detected user, or interpreting input data of physical space information data associated with the of the detected target object;
determining a system response in response of the input data and mapping a pathway to walk through the physical space to interact with the detected user;
determining a system response in response of the input data and mapping a pathway to walk through the physical space to interact with the detected target object.

19. The humanoid robot of claim 11, wherein the control system further comprising:
AI decision-making algorithms to generate a path planning based on sensors, cameras, and GPS generating route and positioning data for traveling such that, the humanoid robot is to identify and mark at least one of a position or orientation of at least one pathway in an operating environment of the humanoid robot based on sensor data and camera data, and provide instruction for the humanoid robot to follow the pathway via the marks.

20. (canceled)

21. (canceled)

22. A humanoid robot comprising:
a humanoid robot comprising artificial intelligence configured for completing complex human like handling actions based on AI algorithms and/or user interface instruction;
a head and body rotatably linked together by an actuating collar and fulcrum torso module arrangement, the actuating collar rotatably coupled to robotic arms, wherein the robotic arms are provided with manipulator implements configured for handling objects or accomplish other physical actions, wherein the fulcrum torso module linked to actuating pelvis which are rotatably coupled to robotic legs;
an actuating spine configured for connecting the fulcrum torso module with the actuating pelvis such that, the fulcrum torso module and actuating hip can achieve twisting motion;
wherein the robotic legs are provided with an end effector connecting to a foot, or a wheel, or a boot-skate configured for providing multiple degrees of freedom to achieve walking motion or skating motion, wherein the foot configured for gripping to a surface, connects to the end effector, the wheel including a motor connected therein, wherein the motor to provide fore or aft propulsion with braking capability, the boot-skate is a boot like fender a wheel configuration;
one or more LED lighting units may include head lights, tail, brake lights and turn signals, and can work as a flash light, wherein the LED lighting units may be affixed on the robotic arm to light up an object being handled, or affixed on robotic legs and/or on the fender of the boot-skate;
batteries for providing power, a battery charging system, and a charging module situating on the body configured to receive an external charge port charging process through AI algorithms instruction or user interface instruction;
wherein the robotic legs providing a hip extension, a knee extension, an ankle and a wheel rotation providing a Z axis of rotation; the hip connecting to the chassis, the hip having a Y axis of rotation; and the ankle extension has both a Z axis and Y axis of rotation;
the body's actuating collar, fulcrum torso module, actuating waist, actuating pelvis, robotic arms, robotic legs arrangement further comprising actuators being at least power driven by one of; electricity, pneumatic, hydraulic, or other motorized process;
wherein the head or the body comprising proximity sensors and cameras configured for detecting objects surrounding the humanoid robot, the sensors and cameras providing object data and image data to a control system;
AI decision-making algorithms generating instruction for controlling rotational speed and maneuver position of the humanoid robot based on modulated signals provided from sensor data and camera data;
a wireless communication system associating with at least one of; I/O devices, smart external devices utilizing Wi-Fi, Bluetooth, APPS, cloud computing through the Internet of Things (IoT) and cloud management;
user interface providing instruction through wireless communication such that, the humanoid robot operates autonomously to complete tasks during an operation mode which may involve; an autonomous mode or a semiautonomous mode for the controlling of operating modes involving one of; a walking mode, a driving mode, a dancing mode, a leaping mode, a battery charging mode, or other maneuvering modes;
AI decision-making algorithms for controlling rotational speed and maneuver position of one or more joint mechanisms, servos, actuators, and manipulators to accomplish maneuvering actions;
AI decision-making algorithms for generation path planning based on sensors, cameras, and GPS generating route and positioning data for traveling;
AI decision-making algorithms for controlling humanoid robots to self-dock on a portable smart docking station providing options to automatically transport the humanoid robot or to charge the humanoid robot not causing a user to be involved with the docking, transporting or charge process itself;
batteries for providing power, a battery charging system, and a charging module situating on the body configured to receive an external charge port charging process through AI algorithms instruction or user interface instruction;
a wiring array and electrical connections linking regulated battery power to the aforementioned components.

23. A humanoid robot comprising:
a humanoid robot comprising artificial intelligence configured for completing complex human like physical actions based on AI algorithms and/or user interface instruction;
a head and body rotatably linked together by an actuating collar and fulcrum torso module arrangement, the actuating collar rotatably coupled to robotic arms, wherein the robotic arms are provided with manipulator implements configured for handling objects or accomplish other physical actions, wherein the fulcrum torso module linked to actuating pelvis which are rotatably coupled to robotic legs, wherein the robotic legs are provided with a foot or a wheel configured for providing multiple degrees of freedom to achieve walking motion or rolling motion, wherein the wheel including a motor connected therein, wherein the motor to provide fore or aft propulsion with braking capability;
wherein the head or the body comprising proximity sensors and cameras configured for detecting objects surrounding the humanoid robot, the sensors and cameras providing object data and image data to a control system;
AI decision-making algorithms for controlling rotational speed and maneuver position of one or more joint mechanisms, servos, actuators, and manipulators to accomplish maneuvering actions;
the body's actuating collar, fulcrum torso module, actuating waist, actuating pelvis, robotic arms, robotic legs arrangement further comprising actuators being at least power driven by one of; electricity, pneumatic, hydraulic, or other motorized process;
AI decision-making algorithms for generation path planning based on sensors, cameras, and GPS generating route and positioning data for traveling;
user interface providing instruction through wireless communication such that, the humanoid robot operates autonomously to complete tasks;
a wireless communication system involving one of; I/O devices, smart external devices utilizing Wi-Fi, Bluetooth, APPS, cloud computing through the Internet of Things (IoT);
an autonomous mode or a semiautonomous mode for the controlling of operating modes involving one of; a walking mode, a driving mode, a dancing mode, a leaping mode, a battery charging mode, or other maneuvering modes;
batteries for providing power, a battery charging system;
a charging module situating on the body, wherein the charging module configured to receive an external charge port charging process through AI algorithms instruction or user interface instruction;
AI decision-making algorithms for controlling humanoid robots to self-dock on a portable docking station;
wherein a control system configured for autonomously charging the batteries of the humanoid robot;
the control system configured for controlling a charging procedure of the humanoid robot when docked an external battery charging station;
the control system is configured for detecting whether charging of the humanoid robot is complete;
the control system configured for disconnecting the charging process in response to the charging of the humanoid robot being complete.
